(19) United States
(12) Patent Application Publication
(10) Pub. No.: US 2021/0274480 A1
(43) Pub. Date: Sep. 2, 2021

(54) BASE STATION

(71) Applicant: NTT DOCOMO, INC., Tokyo (JP)

(72) Inventors: Kazuki Takeda, Tokyo (JP); Satoshi Nagata, Tokyo (JP); Shaozhen Guo, Beijing (CN); Lihui Wang, Beijing (CN); Xiaolin Hou, Beijing (CN)

(73) Assignee: NTT DOCOMO, INC., Tokyo (JP)

(21) Appl. No.: 17/260,038

(22) PCT Filed: Jul. 17, 2018
(86) PCT No.: PCT/JP2018/026751

§ 371 Date: Jan. 13, 2021

(51) Int. Cl. H04W 72/04; H04L 5/14

(52) U.S. Cl. CPC H04W 72/042; H04W 88/08; H04L 5/14

(57) ABSTRACT

A base station according to an aspect of the present disclosure includes a transmitting section that transmits, in monitoring occasions with a certain period, downlink control information indicating a slot format for a certain cell, and a control section that controls transmission of the downlink control information in at least one of a plurality of cells including the certain cell. This allows communication in TDD to be appropriately controlled.

### TECHNICAL FIELD

The present disclosure relates to a base station in next-generation mobile communication systems.

### BACKGROUND ART

In UMTS (Universal Mobile Telecommunications System) network, the specifications of Long Term Evolution (LTE) have been drafted for the purpose of further increasing high speed data rates, providing lower latency and so on (see Non-Patent Literature 1). For the purpose of further high capacity, advancement of LTE (LTE Rel. 8, Rel. 9), and so on, the specifications of LTE-A (LTE-Advanced, LTE Rel. 10, Rel. 11, Rel. 12, Rel. 13) have been drafted.

Successor systems of LTE (referred to as, for example, “FRA (Future Radio Access),” “5G (5th generation mobile communication system),” “5G+(plus),” “NR (New Radio),” “NX (New radio access),” “FX (Future generation radio access),” “LTE Rel. 14,” “LTE Rel. 15” (or later versions), and so on) are also under study.

Existing LTE systems (for example, LTE Rel. 8 to Rel. 13) support time division duplex (TDD) involving switching between uplink (UL) and downlink (DL) communications.

Specifically, the existing LTE systems in principle semi-statically control switching of a transmission direction based on a UL/DL configuration specifying the type of each of subframes (a UL subframe, a DL subframe, or a special subframe including a DL symbol, a guard symbol, and a UL symbol) in a radio frame, in unit of subframe of 1 ms. For the UL/DL configuration, seven types are specified.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

For TDD in future radio communication systems (hereinafter, simply referred to as NR), studies have been conducted about semi-static or dynamic control of switching of the transmission direction using certain time units (for example, a slot or symbol being a time unit based on subcarrier spacing (SCS)) in order to switch the transmission direction more flexibly than in existing LTE systems.

Specifically, for NR, studies have been conducted about determination of the type of each of symbols (for example, a DL symbol, a UL symbol, or a symbol not depending on whether the transmission direction is DL or UL (flexible symbol)) in the slot, based on downlink control information (DCI) in a user terminal. The type of each of the symbols in the slot is referred to as a slot format, the format of slots, and so on.

However, in NR, a user terminal may fail to appropriately determine the slot format in a certain cell (for example, a cell to be activated or a cell for which the slot format is specified by DCI detected by a plurality of cells), resulting in a failure to appropriately control communication in TDD.

Thus, an object of the present disclosure is to provide a base station that can appropriately control communication in TDD.

### Solution to Problem

A base station according to an aspect of the present disclosure includes a transmitting section that transmits, in monitoring occasions with a certain period, downlink control information indicating a slot format for a certain cell, and a control section that controls transmission of the downlink control information in at least one of a plurality of cells including the certain cell.

### Advantageous Effects of Invention

According to an aspect of the present disclosure, communication in TDD can be appropriately controlled.

### BRIEF DESCRIPTION OF DRAWINGS

FIG. 1 is a diagram to show an example of a slot format;

FIG. 2 is a diagram to show an example of a determination of the slot format based on DCI format 2_0;

FIG. 3 is a diagram to show an example of a determination of the slot format based on DCI format 2_0 for a case where activation of a CC is controlled;

FIG. 4 is a diagram to show an example of cross carrier monitoring;

FIG. 5 is a diagram to show an example of a first determination operation for the slot format according to a first aspect;

FIG. 6 is a diagram to show an example of a second determination operation for the slot format according to the first aspect;

FIG. 7 is a diagram to show an example of first half duplex communication according to the first aspect;

FIG. 8 is a diagram to show an example of second half duplex communication according to the first aspect;

FIG. 9 is a diagram to show another example of second half duplex communication according to the first aspect;

FIG. 10 is a diagram to show an example of a second determination operation for the slot format according to a second aspect;

FIG. 11 is a diagram to show an example of a third determination operation for the slot format according to the second aspect;

FIG. 12 is a diagram to show an example of a schematic structure of a radio communication system according to the present embodiment;

FIG. 13 is a diagram to show an example of an overall structure of a radio base station according to the present embodiment;

FIG. 14 is a diagram to show an example of a functional structure of the radio base station according to the present embodiment;

FIG. 15 is a diagram to show an example of an overall structure of a user terminal according to the present embodiment;

FIG. 16 is a diagram to show an example of a functional structure of the user terminal according to the present embodiment; and

FIG. 17 is a diagram to show an example of a hardware structure of the radio base station and the user terminal according to the present embodiment.

### Description of Embodiments

In NR, it is assumed that a transmission direction (at least one of UL (Uplink), DL (Downlink), and flexible) of a slot and at least one of symbols in the slot is semi-statically or dynamically controlled.

The transmission direction (also referred to as format, configuration, or the like) of a certain number of consecutive slots or symbols in the consecutive slots is also referred to as slot configuration, UL-DL configuration for time division duplex (TDD) (TDD-UL-DL Configuration (tdd-UL-DL-Configuration)), and so on.

Information related to the TDD-UL-DL configuration (TDD-UL-DL configuration information) may be reported (configured) from a base station (which may be also referred to, for example, as a “BS (Base Station),” a “transmission/reception point (TRP),” an “eNB (eNodeB),” a “gNB (NR NodeB),” and the like) to a user terminal through higher layer signaling.

Here, the higher layer signaling may be, for example, at least one of the following:
RRC (Radio Resource Control) signaling;
MAC (Medium Access Control) signaling (for example, MAC control elements (MAC CE), MAC PDUs (Protocol Data Units));
Information (for example, master information block (MIB)) transmitted by a broadcast channel (for example, PBCH (Physical Broadcast Channel)); and
System information (for example, system information blocks (SIBs), minimum system information (RMSI (Remaining Minimum System Information))), and other system information (OSI).

The TDD-UL-DL configuration information may be given in a cell-specific manner (commonly to a group including one or more user terminals (UE-group common)) or a user-terminal-specific (UE-specific) manner.

For example, the cell-specific TDD-UL-DL configuration information (also referred to as tdd-UL-DL-ConfigurationCommon, tdd-UL-DL-ConfigurationCommon2, and so on) may include information indicating at least one of the following:
Subcarrier spacing used as a reference (μ_{ref});
Periods of patterns in the DL and UL (slot configuration period P);
The number of slots only of DL symbols (full DL slots) (dₛₗₒₜ);
The number of consecutive DL symbols in a slot succeeding the full DL slots (d_{symbz});
The number of slots only of UL symbols (full UL slots) (μₛₗₒₜ); and
The number of UL symbols in a slot succeeding the full UL slots (d_{symb}).

The user-terminal-specific TDD-UL-DL configuration information (also referred to as tdd-UL-DL-ConfigDedicated and so on) may include information indicating at least one of the following:
A set of one or more slot configurations for overwriting at least one of UL and DL allocations provided by cell-specific TDD-UL-DL configuration information;
A slot index provided by each slot configuration; and
The transmission direction of symbols in a slot provided by each slot configuration (for example, all the symbols in the slot are DL symbols, all the symbols in the slot are UL symbols, and symbols not explicitly specified as DL or UL symbols are flexible symbols).

In a case where the cell-specific TDD-UL-DL configuration information (tdd-UL-DL-ConfigurationCommon or tdd-UL-DL-ConfigurationCommon2) is provided, the user terminal may determine the slot format of each slot over a certain number of slots based on the cell-specific TDD-UL-DL configuration information.

In a case where, in addition to the cell-specific TDD-UL-DL configuration information, the user-terminal-specific TDD-UL-DL configuration information (tdd-UL-DL-ConfigDedicated) is provided, the user terminal may override (modify, or change) flexible symbols in a certain number of slots specified by the cell-specific TDD-UL-DL configuration information, based on the user-terminal-specific TDD-UL-DL configuration information. The format of a slot (pattern or transmission direction) configured based on at least one of the cell-specific TDD-UL-DL configuration information and the user-terminal-specific TDD-UL-DL configuration information as described above may also be referred to as a Semi-static TDD pattern, a semi-static slot format, a semi-static pattern, and so on.

For NR, studies have been conducted about reporting, to a user terminal with a certain period, of information related to the formats of a certain number of slots (for example, slot format identities (SFIs)).

The SFI may be included in downlink control information (DCI) transmitted on a downlink control channel (also referred to as, for example, a PDCCH (Physical Downlink Control Channel), a group common (GC) PDCCH, and so on).

DCI including one or more SFIs may be referred to as DCI format 2_0, a DCI format for an SFI, a DCI format for slot format reporting, DCI for an SFI, SFI-DCI, and simply SFI. DCI format 2_0 may be different from a DCI format (for example, DCI format 0_0, 0_1, 1_0, or 1_1) used to schedule the downlink shared channel (for example, a PDSCH (Physical Downlink Shared Channel)) or a PUSCH (for example, a PUSCH (Physical Uplink Shared Channel). Note that the “DCI format” may be used interchangeably with the “DCI.”

Cyclic redundancy check (CRC) bits scrambled with a particular identifier (for example, an SFI-RNTI (Slot Format Indication Radio Network Temporary Identifier) may be added to DCI format 2_0. Thus, DCI format 2_0 may be replaced with “DCI CRC-scrambled (scrambled) with the SFI-RNTI.” The SFI-RNTI may be reported from the base station to the user terminal through higher layer signaling.

The size of DCI format 2_0 (payload or payload size) may be configured for (reported to) the user terminal through higher layer signaling.

A combination of one or more SFIs included in DCI format 2_0 may be identified by a certain index (also referred to as an SFI index, an SFI-index, and so on). A combination of slot formats each specified by one or more SFIs in DCI format 2_0 may also be referred to as a slot format combination and so on. Note that the “slot format combination” may be used interchangeably with the “slot formats of one or more slots.”

A set of one or more slot format combinations may be configured for the user terminal for each cell (also referred to as a serving cell, a component carrier (CC), a carrier, and so on) through higher layer signaling (for example, a higher layer parameter “slotFormatCombToAddModList”). Each slot format combination may be identified by a certain identifier (ID, also referred to as slotFormatCombinationId, an SFI index, and so on). The format of a slot (pattern or transmission direction) configured based on at least one of slotFormatCombToAddModList and DCI may also be referred to as a Dynamic TDD pattern, a dynamic slot format, a dynamic pattern, and so on.

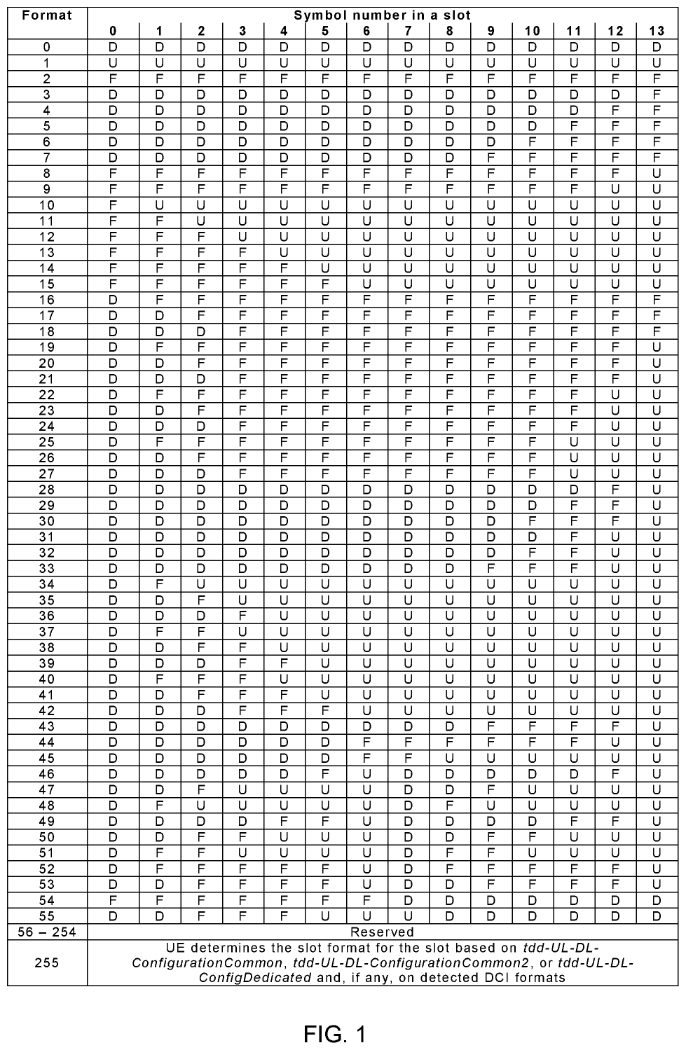

FIG. 1 is a diagram to show an example of the slot format. As shown in FIG. 1, the slot format may indicate the transmission direction of each of the symbols in one slot. In FIG. 1, “D” indicates a DL symbol, a “U” indicates a UL symbol, and “F” indicates a symbol in which either DL or UL transmission may be performed (flexible symbol). For example, in FIG. 1, it is assumed that one slot is constituted of 14 symbols #0 to #13. However, the number of symbols per slot is not limited to this.

For example, FIG. 1 shows 56 types of slot formats #0 to #55 identified by certain indices (also referred to as format indices, formats, SFIs, and so on). Note that a particular format index (for example, 255) may indicate a particular application. The particular application may be, for example, determination of the slot format based on at least one of the cell-specific TDD-UL-DL configuration information and the user-terminal-specific TDD-UL-DL configuration information and execution of a particular operation in configured flexible symbols.

A certain field value in DCI format 2_0 (for example, an SFI-index field value or an SFI index field value) may indicate the slot format of each of a certain number of slots (the above-described slot format combination, the identifier of the slot format combination, or the SFI-index). The certain number of slots may be a number larger than the period with which DCI format 2_0 is monitored (also referred to as monitoring periodicity, PDCCH monitoring periodicity, SFI monitoring periodicity, and so on).

The user terminal may monitor (blind-decode) DCI format 2_0 with the monitoring periodicity. The PDCCH monitoring periodicity may be configured for the user terminal through higher layer signaling.

In a case where the user terminal detects DCI format 2_0 in a certain slot, the slot formats of a certain number of consecutive slots in DCI format 2_0 may be determined based on a certain field value in DCI format 2_0. Specifically, the user terminal may determine the slot format combination indicated by the certain field value in DCI format 2_0 from among the slot format combinations configured through higher layer signaling.

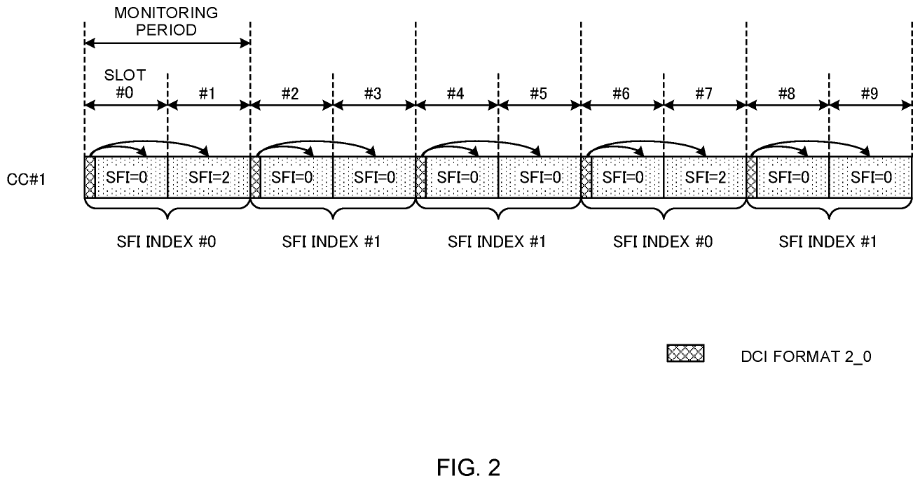

FIG. 2 is a diagram to show an example of a determination of the slot formats based on DCI format 2_0. For example, FIG. 2 shows an example in which a monitoring period for DCI format 2_0 is 2 slots. In FIG. 2, as an example, it is assumed that a set including a plurality of slot format combinations is configured for the user terminal. The plurality of slot format combinations may be identified by different indices (here, SFI indices #0 and #1). The plurality of slot format combinations may indicate different combinations of slot formats (see FIG. 1) of one or more slots (here, 2 slots).

For example, in FIG. 2, the certain field value in DCI format 2_0 detected in slot #0 may indicate (the identifier (SFI index #0) of) slot format combination #0. The user terminal may determine slots #0 and #1 to be respectively in slot formats #0 and #2 based on the certain field value. Similarly, the user terminal may determine the slot formats of a certain number of slots including the slot in which DCI format 2_0 is detected, based on the certain field value in DCI format 2_0 detected in slots #2, #4, #6, and #8.

Incidentally, in NR, it is assumed that communication is performed by using one or more frequency bands configured for the user terminal. For example, one or more CCs (also referred to as cells, serving cells, carriers, and so on) may be configured for the user terminal. The user terminal may be configured with one or more bandwidth part (BWP) included in a certain CC. Here, the BWP corresponds to one or more partial frequency bands within the CC configured in NR. The BWP may be referred to as a “partial frequency band,” a “partial band,” and the like.

The user terminal may control activation and deactivation of at least one of the CCs and BWPs configured through higher layer signaling. Note that the activation may be enabling configuration information concerning at least one of the CCs and the BWPs. The deactivation may be disabling configuration information concerning at least one of the CCs and the BWPs.

In a case where one or more CCs are configured for the user terminal, monitoring of DCI format 2_0 (also referred to as SFI monitoring, GC-PDCCH monitoring, and so on) may be performed in the same CC as that for which the slot format is specified by using DCI format 2_0 (also referred to as the same carrier monitoring, the same CC monitoring, the same cell monitoring, and so on) or may be performed in a CC different from the CC (also referred to as cross carrier monitoring, cross CC monitoring, cross cell monitoring, and so on).

In the cross carrier monitoring, a field for the SFI index common to one or more CCs may be provided in a single DCI format 2_0. In this case, the slot format combination indicated by the field value may be applied to one or more CCs.

Alternatively, in the cross carrier monitoring, the field for the SFI index may be provided for each CC in a single DCI format 2_0 for each CC. In this case, the slot format combination indicated by each field value may be applied to the corresponding CC.

The user terminal may be requested to monitor DCI format 2_0 at each certain period configured for the BWP activated within a certain CC (active BWP). Monitoring of DCI format 2_0 may be performed for each state (TCI state) of a transmission configuration indicator (TCI).

The TCI state may indicate (include) information related to quasi-co-location (QCL) of a certain channel (for example, the PDCCH). For example, the TCI state may indicate, for example, information (for example, a resource for a DL-RS) related to a downlink reference signal (DL-RS) that is in a QCL relationship with a DMRS (or the antenna port for the DMRS) for the PDCCH, on which DCI format 2_0 is transmitted. A difference in TCI state may mean that the PDCCH is transmitted by using a different beam or that the PDCCH is transmitted from a different TRP.

Note that in a case where one or more BWPs are configured for the user terminal, monitoring of DCI format 2_0 may be performed in the same BWP as that for which the slot format combination is specified by using DCI format 2_0 (also referred to as the same BWP monitoring, and so on) or may be performed in a BWP different from the BWP (also referred to as cross BWP monitoring, and so on).

However, in a case where activation or deactivation of the CC is controlled, the user terminal may fail to appropriately determine the slot formats of one or more slots.

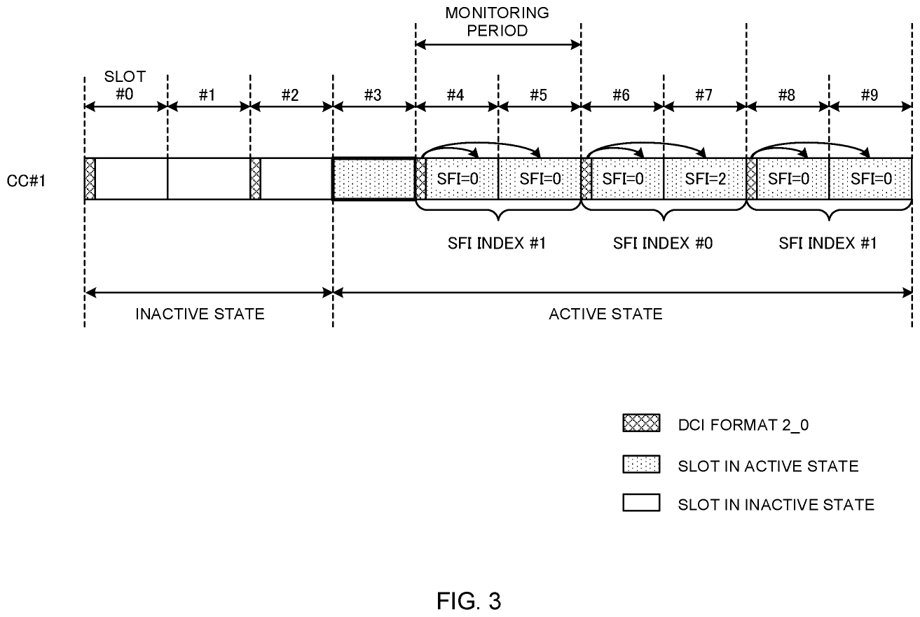

FIG. 3 is a diagram to show an example of a determination of the slot format based on DCI format 2_0 for a case where activation of the CC is controlled. Note that prerequisites for FIG. 3 are similar to the prerequisites for FIG. 2 and that differences from FIG. 2 are focused on in the following description.

For example, in FIG. 3, the user terminal activates CC #0 (for example, a secondary cell (SCell)) (causes the secondary cell to transition from an inactive state to an active state) in slot #3. In FIG. 3, slot #3 has no monitoring occasions for DCI format 2_0. Note that the monitoring occasions refer to certain times for monitoring of the PDCCH (DCI) and are also referred to as PDCCH monitoring occasions, monitoring periods, control resource sets (CORESETs), sets including one or more search spaces (search space sets), and so on.

Thus, the user terminal is prevented from determining the slot format until the user terminal detects DCI format 2_0 in the next monitoring occasion (here, slot #4). In other words, after CC #0 is activated, the user terminal fails to recognize the slot format of one or more slots (here, slot #3) before the monitoring occasion. This may prevent activated CC #0 from being appropriately communicated.

In a case where DCI format 2_0 specifying the slot format (or slot format combination) for a particular CC is detected in one or more CCs, the user terminal may fail to appropriately determine the slot formats of one or more slots in the particular CC.

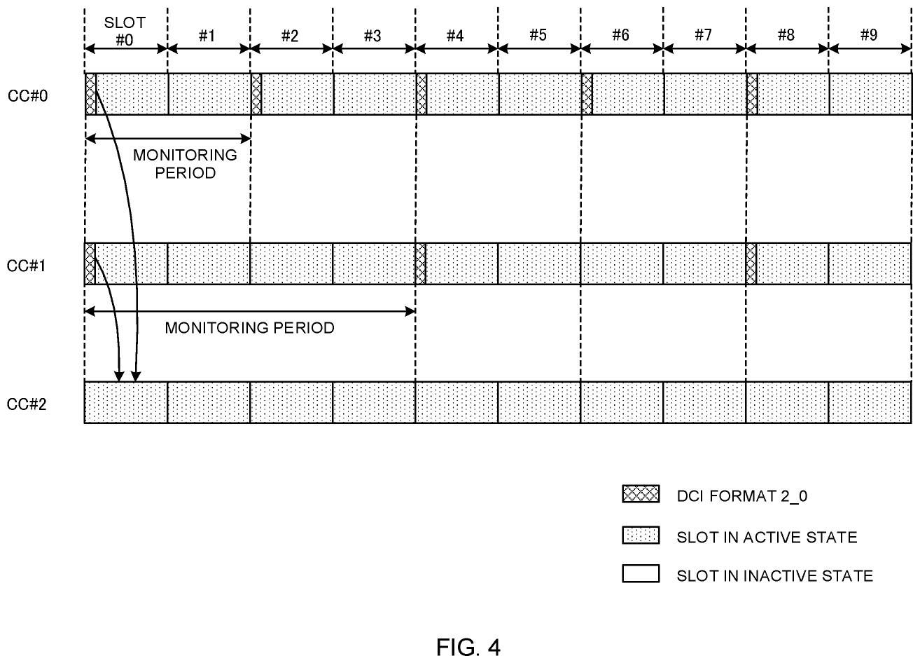

FIG. 4 is a diagram to show an example of the cross carrier monitoring. FIG. 4 shows an example in which the user terminal monitors, in both CC #0 and CC #1, DCI format 2_0 specifying the slot format combination for CC #2.

For example, in a case where a plurality of the DCI formats 2_0 specifying the slot format combination for CC #2 is detected in CC #0 and CC #1 as shown in FIG. 4, the problem is how a user terminal determines the slot formats of one or more slots in CC #2. Such a problem is not limited to the case of the cross carrier monitoring and may occur in a case where a plurality of the DCI formats 2_0 specifying the slot format of the same slot in one CC are detected by a plurality of CCs.

Thus, the inventors of the present invention studied a method (first aspect) for enabling appropriate determination of the slot format in a case where activation or deactivation of the CC is controlled and a method (second aspect) for enabling appropriate determination of the slot format of the same slot in one of a plurality of CCs in a case where DCI format 2_0 specifying the slot format is detected.

The present embodiment will be described in detail with reference to the drawings as follows. In the present embodiment, DCI format 2_0 including one or more SFIs described above is illustrated as an example of DCI. However, no such limitation is intended, and any DCI may be used that indicates a slot format.

### (First Aspect)

In a first aspect, description is given about an operation for determining, in a case where a certain cell is activated, the slot format for a slot or symbol before the next monitoring occasion for the DCI for the certain cell.

Note that a case where activation or deactivation of a cell (CC or carrier) is controlled will be described below but that the present embodiment can be applied as appropriate to a case where activation or deactivation of a BWP is controlled.

### <Determination of Slot Format>

### <<First Determination Operation>>

In a first determination operation, in a case where a particular cell is activated, the user terminal may determine the slot format of a slot before the next monitoring occasion of the particular cell, based on DCI format 2_0 detected in another cell. Another cell described above may be cell meeting a particular condition that the cell has the same operating band as that of the particular cell activated (also referred to as an NR operating band, a band, and so on), the same frequency range (FR) as that of the particular cell activated, the same PUCCH group or the same cell group (CG) as that of the particular cell activated, or the same timing advance group (TAG) as that of the particular cell activated.

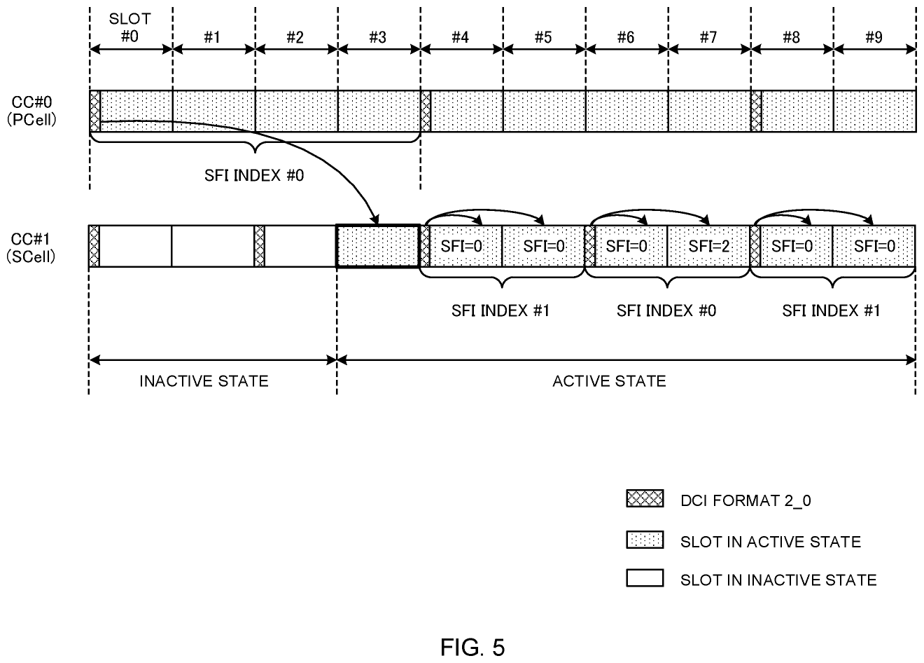

FIG. 5 is a diagram to show an example of the first determination operation for the slot format according to the first aspect. Note that, in FIG. 5, differences from FIG. 3 are focused on in the following description. For example, in FIG. 5, CC #0 is assumed to be a primary cell (PCell), but no such limitation is intended. CC #0 may be one of a primary secondary cell (PSCell), a physical uplink control channel (PUCCH) cell, and an SCell. CC #1 is assumed to be an SCell, but no such limitation is intended.

As shown in FIG. 5, in a case where CC #1 is activated in slot #3, the user terminal may determine the slot format of slot #3 before the next monitoring occasion (here, slot #4) in CC #1 based on the certain field value in DCI format 2_0 detected in another CC #0.

Specifically, the user terminal may determine the slot format of the slot #3 based on the certain field value in the closest DCI format 2_0 detected in another CC before activation of CC #1.

Accordingly, in FIG. 5, DCI format 2_0 (or the certain field value in DCI format 2_0) detected in CC #0 indicates the slot format for CC #1 (slot format combination, SFI, or SFI index). In other words, the user terminal may perform cross carrier monitoring on DCI format 2_0 indicating the slot format of slot #3 before the next monitoring occasion in CC #1.

Note that DCI format 2_0 may include a field (for example, a carrier identification field) indicating a carrier indicating the slot format.

In the first determination operation, the user terminal can appropriately determine, by cross carrier monitoring, the slot format of a slot before the next monitoring occasion in the activated CC.

### <<Second Determination Operation>>

In a second determination operation, in a case where a particular cell is activated, the user terminal may determine the slot format of a slot or the transmission direction (Tx direction) of each symbol before the next monitoring occasion in the particular cell as in a case where no DCI format 2_0 can be detected.

Specifically, in a case where the user terminal detects no DCI format 2_0, for symbols configured as DL or UL symbols by using at least one of the above-described cell-specific TDD-UL-DL configuration information and user-terminal-specific TDD-UL-DL configuration information, the user terminal may perform communication in accordance with the configuration.

On the other hand, in a case where the user terminal detects no DCI format 2_0, for symbols configured as flexible symbols by using at least one of the above-described cell-specific TDD-UL-DL configuration information and user-terminal-specific TDD-UL-DL configuration information, the user terminal may perform at least one of the following operations:
Monitoring of the PDCCH (DCI) in configured flexible symbols (reception of the PDCCH);
In particular symbols of the configured flexible symbols, stoppage (cancellation) of transmission of an UL signal (for example, a PUSCH, a PUCCH, a sounding reference signal (SRS), or a random access channel (PRACH (Physical Random Access Channel)) configured through higher layer signaling, the particular symbols may be equal, in symbol number, to a preparation time corresponding to a timing capability of the PUSCH after the last symbol in a CORESET in which detection of DCI format 2_0 is configured; and
For the configured flexible symbols, assumption of non-transmission of a DL signal (for example, the PDSCH or a channel state information reference signal (CSI-RS)) configured through higher layer signaling (stoppage (cancellation) of reception of the DL signal).

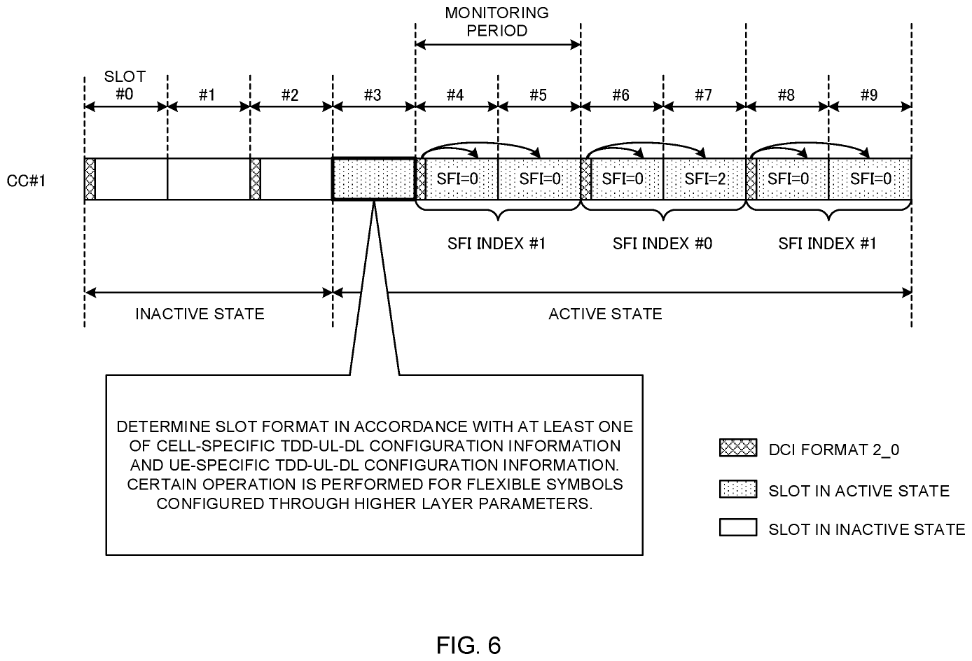

FIG. 6 is a diagram to show an example of the second determination operation for the slot format according to the first aspect. Note that description will be given with reference to FIG. 6 with differences from FIG. 3 focused on. Note that FIG. 6 illustrates a case where the same carrier monitoring is performed but that the cross carrier monitoring may be applied.

As shown in FIG. 6, in a case where CC #1 is activated in slot #3, the user terminal may determine the slot format of slot #3 before the next monitoring occasion (here, slot #4) in CC #1 based on at least one of the above-described cell-specific TDD-UL-DL configuration information and user-terminal-specific TDD-UL-DL configuration information.

In FIG. 6, the user terminal may perform a particular operation (for example, reception of the PDCCH, stoppage (cancellation) of reception of the DL signal configured through higher layer signaling, stoppage (cancellation) of transmission of the UL signal configured through higher layer signaling, or the like), in flexible symbols configured based on at least one of the above-described cell-specific TDD-UL-DL configuration information and user-terminal-specific TDD-UL-DL configuration information.

In the second determination operation, the user terminal determines the transmission direction of the slot or symbol before the next monitoring occasion in the activated CC as in a case where detection of DCI format 2_0 fails. Thus, the transmission direction of the slot or symbol before the next monitoring occasion in the activated CC can be appropriately determined.

### <<Third Determination Operation>>

In a third determination operation, to activate a particular cell, the user terminal may determine the slot format of a slot or the transmission direction of each symbol before the next monitoring occasion in the particular cell as in a case where a particular SFI (for example, 255 in FIG. 1) is detected.

In a case where the SFI in DCI format 2_0 shows a particular value (for example, “255” in FIG. 1), for symbols configured as DL or UL symbols by using at least one of the above-described cell-specific TDD-UL-DL configuration information and user-terminal-specific TDD-UL-DL configuration information, the user terminal may perform communication in accordance with the configuration.

In a case where the SFI in DCI format 2_0 shows a particular value (for example, “255” in FIG. 1), for symbols configured as flexible symbols by using at least one of the above-described cell-specific TDD-UL-DL configuration information and user-terminal-specific TDD-UL-DL configuration information, the user terminal may perform at least one of the following operations:
Monitoring of the PDCCH (DCI) in configured flexible symbols (reception of the PDCCH);
In particular symbols of the configured flexible symbols, transmission of the UL signal (for example, the PUSCH, PUCCH, SRS, or PRACH) configured through higher layer signaling; and
In the configured flexible symbols, reception of the DL signal (for example, the PDSCH or CSI-RS) configured through higher layer signaling.

The third operation differs from the second operation in that transmission of the UL signal and reception of the DL signal configured through higher layer signaling are performed in flexible symbols configured based on at least one of the above-described cell-specific TDD-UL-DL configuration information and user-terminal-specific TDD-UL-DL configuration information. Thus, FIG. 6 can be applied to the third determination operation by changing the operation performed for the flexible symbols configured in slot #3 through higher layer parameter.

In the third determination operation, the user terminal determines the transmission direction of the slot or symbol before the next monitoring occasion in the activated CC as in a case where the SFI in DCI format 2_0 shows a particular value (for example, “255” in FIG. 1). Thus, the transmission direction of the slot or symbol before the next monitoring occasion in the activated CC can be appropriately determined.

### <Half Duplex Communication>

In half duplex communication, the user terminal does not simultaneously perform transmission of the UL signal and reception of the DL signal in one or more cells. To activate a particular cell, the user terminal subjected to half duplex constraints need not expect simultaneous execution of transmission of the UL signal and reception of the DL signal in the slot or symbol before the next monitoring occasion in the particular cell.

### <<First Half Duplex Communication>>

For first half duplex communication, a case will be described in which the user terminal receives, by the cross carrier monitoring, DCI format 2_0 indicating format of the slot before the next monitoring occasion in the activated cell.

In this case, the user terminal need not expect that the same slot or symbol indicates conflicting transmission directions in a certain frequency band including the activated cell and another cell. The certain frequency band may be, for example, the same operating band (also referred to as an NR operating band, a band, or the like), the same frequency range (FR), the same PUCCH group or the same cell group (CG), or the like.

Here, one operating band may be constituted of a set of an operating band for the UL and an operating band for the DL. The FR may be one of FR1 corresponding to relatively low frequencies (for example, 450 MHz to 6000 MHz) and FR2 corresponding to relatively high frequencies (for example, 24250 MHz to 52600 MHz).

The PUCCH group may include one or more CCs (cells), and the PUCCH may be transmitted in one of the CCs. The cell group may include one or more CCs (cells), and may be one of a master cell group (MCG) including the PSCell or a secondary cell group (SCG) including the PSCell.

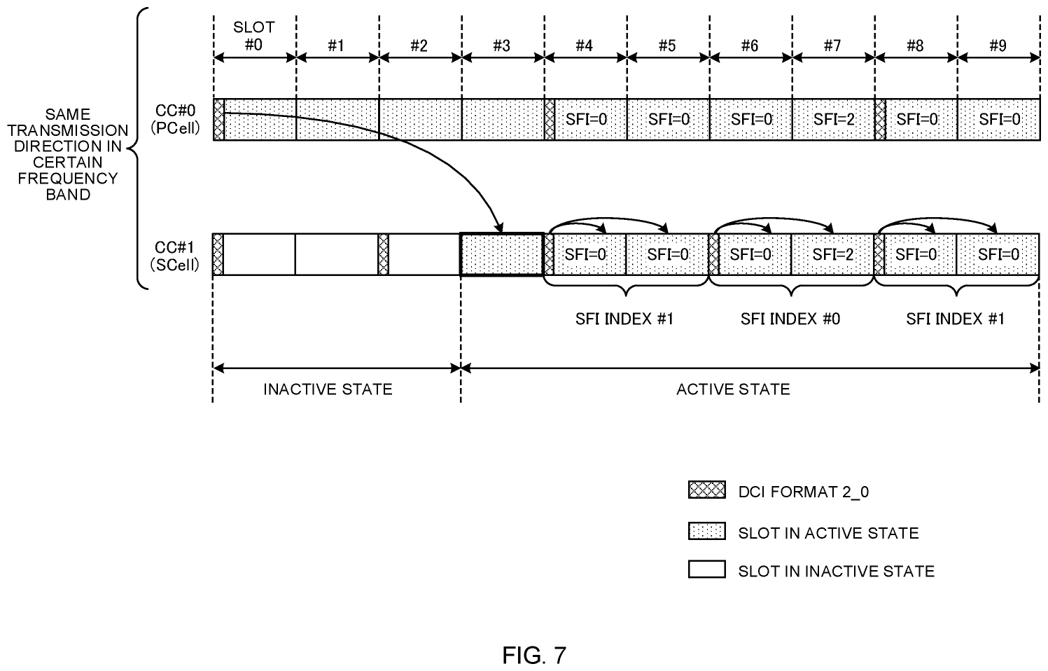

FIG. 7 is a diagram to show an example of first half duplex communication according to the first aspect. Description will be given with reference to FIG. 7 with differences from FIG. 5 focused on. For example, in FIG. 7, in a case where CC #1 is activated, the user terminal may determine the slot format of slot #3 before the next monitoring occasion in CC #1 based on the certain field value in DCI format 2_0 detected (monitored by the cross carrier monitoring) in CC #0.

In FIG. 7, the user terminal is subjected to half duplex constraints. Thus, between CC #0 and CC #1 in a certain frequency band (for example, in FIG. 7, the same cell group), the slot format for CC #1 may be specified such that the same slot (for example, slot #3) or the same symbol has the same transmission direction.

As described above, in FIG. 7, for the user terminal subjected to half duplex constraints, the same slot format is specified between a plurality of CCs in a certain frequency band (for example, the operating band, FR, PUCCH group, or CG). Thus, the user terminal subjected to half duplex constraints can appropriately communicate in the CCs aggregated in the certain frequency band.

Note that a network (for example, one or more base stations) may control generation of DCI format 2_0 monitored by the cross carrier monitoring such that, between a plurality of CCs (for example, in FIG. 7, CC #0 and CC #1) in the certain frequency band, the same slot or the same symbol has the same transmission direction.

### <<Second Half Duplex Communication>>

For second half duplex communication, a case will be described in which the user terminal does not receive, by the cross carrier monitoring, DCI format 2_0 indicating format of the slot before the next monitoring occasion in the activated cell.

In a case where the cell-specific TDD-UL-DL configuration information and user-terminal-specific TDD-UL-DL configuration information for the activated cell are not configured, the user terminal may apply the transmission direction of another cell to the same slot or the same symbol in the activated cell.

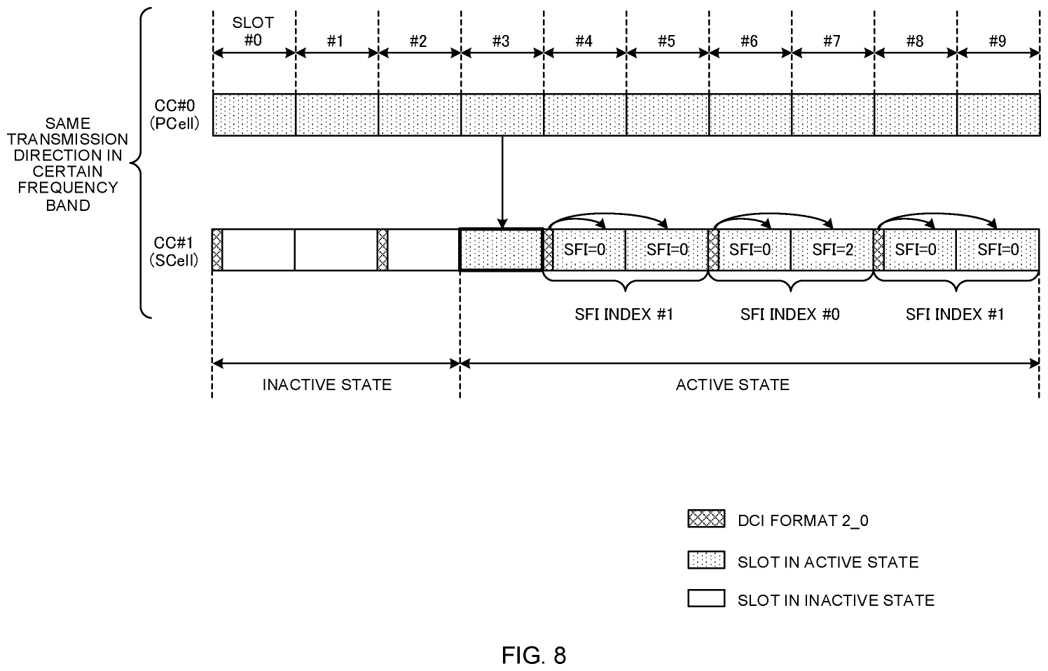

FIG. 8 is a diagram to show an example of the second half duplex communication according to the first aspect. FIG. 8 differs from FIG. 7 in that the cross carrier monitoring for slot #3 before the next monitoring occasion in the activated cell is not performed. In the following, differences from FIG. 7 will be mainly described.

In FIG. 8, the slot format of slot #3 in CC #1 is determined based on at least one of the cell-specific TDD-UL-DL configuration information, user-terminal-specific TDD-UL-DL configuration information, and DCI format 2_0 for CC #0.

In FIG. 8, for the user terminal, at least one of the cell-specific TDD-UL-DL configuration information and user-terminal-specific TDD-UL-DL configuration information for CC #1 is not configured. Thus, the transmission direction of each symbol in slot #3 before the next monitoring occasion in the activated CC #1 can be determined to be the same as the transmission direction of each symbol in another CC #0.

Alternatively, in a case where the cell-specific TDD-UL-DL configuration information and user-terminal-specific TDD-UL-DL configuration information for the activated cell are configured, the user terminal may follow the transmission direction configured for the slot or the symbol based on the TDD-UL-DL configuration information. In this case, it need not be expected that the same slot or symbol in a certain frequency band has conflicting transmission directions.

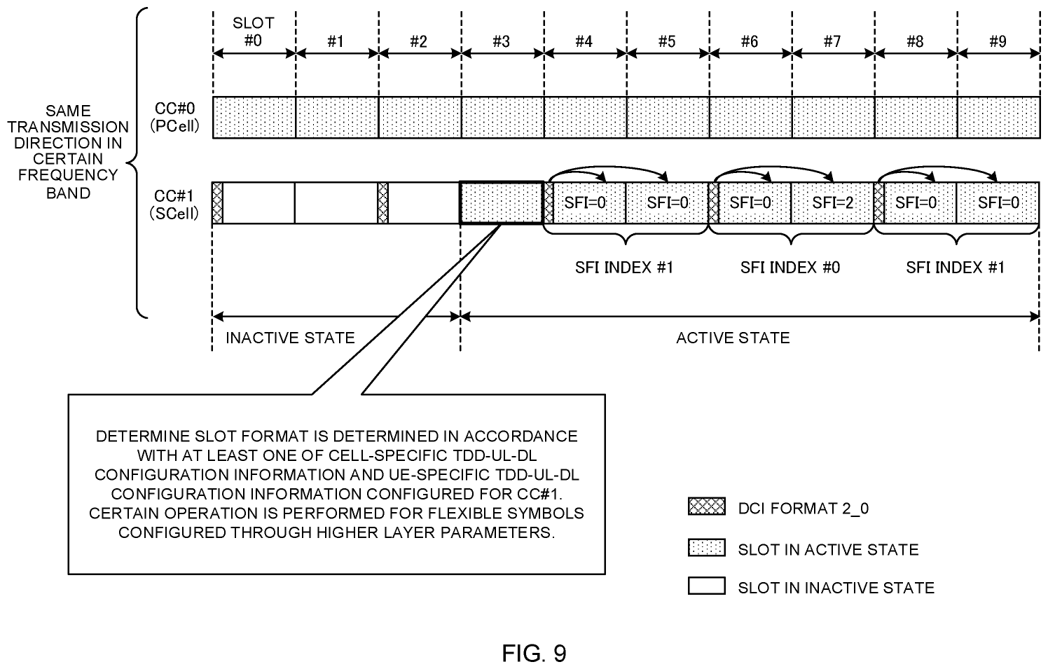

FIG. 9 is a diagram to show another example of the second half duplex communication according to the first aspect. FIG. 9 differs from FIG. 8 in that, for activated CC #0, the cell-specific TDD-UL-DL configuration information and the user-terminal-specific TDD-UL-DL configuration information are configured. In the following, differences from FIG. 8 will be mainly described.

In FIG. 9, the transmission direction of each symbol in slot #3 before the next monitoring occasion in activated CC #1 is determined based on at least one of the cell-specific TDD-UL-DL configuration information and user-terminal-specific TDD-UL-DL configuration information for CC #1.

Note that the user terminal may perform a particular operation in “flexible symbols” (this may be assumed to be “unknown”) in slot #3 configured based on at least one of the cell-specific TDD-UL-DL configuration information and user-terminal-specific TDD-UL-DL configuration information for CC #1.

Specifically, the user terminal may perform at least one of the following operations in the flexible symbols:
Stoppage (cancellation) of monitoring of the PDCCH (DCI) in configured flexible symbols (reception of the PDCCH),
In particular symbols of the configured flexible symbols, stoppage (cancellation) of transmission of the UL signal (for example, the PUSCH, PUCCH, SRS, or PRACH) configured through higher layer signaling,
For the configured flexible symbols, assumption of non-transmission of the DL signal (for example, the PDSCH or CSI-RS) configured through higher layer signaling (stoppage (cancellation) of reception of the DL signal).

In FIG. 9, the user terminal does not assume that, between CC #0 and CC #1 in a certain frequency band, the same slot or symbol has conflicting transmission directions. In other words, the network may generate at least one of the cell-specific TDD-UL-DL configuration information and user-terminal-specific TDD-UL-DL configuration information for CC #1 such that, in CC #1, the same slot or symbol as that in CC #0 has the same transmission direction.

According to the first aspect, in a case where a certain cell is activated, the slot format for a slot or symbol before the next monitoring occasion for the DCI for the certain cell can be appropriately determined.

### (Second Aspect)

In a second aspect, an operation will be described in which, in a case where a plurality of the DCI formats 2_0 for a certain cell are received in a plurality of cells, the slot format for the certain cell is determined based on at least one of the plurality of DCI formats 2_0.

### <First Determination Operation>

In a first determination operation, the user terminal need not expect to receive, in a plurality of cells, a plurality of the DCI formats 2_0 for the certain cell. In other words, the user terminal may assume the DCI formats 2_0 for the certain cell are transmitted in a single cell.

The base station may transmit the DCI formats 2_0 for the certain cell in the certain cell (the same cell, the same CC, or the same carrier) or in a single cell other than the certain cell (a cross cell, a cross CC, or a cross carrier).

In the first determination operation, under the control of the base station, the DCI formats 2_0 for a certain cell are transmitted in a single cell, and thus the user terminal can easily determine the slot format. <Second Determination Operation>

A second determination operation differs from the first determination operation in that the user terminal expects to receive, in a plurality of cells, a plurality of the DCI formats 2_0 for the certain cell.

In the second determination operation, the user terminal need not expect that the plurality of DCI formats 2_0 for the certain cell indicate conflicting slot formats (or slot format combinations). In other words, the user terminal may assume that the plurality of DCI formats 2_0 indicate the same slot format (or slot format combination).

In this case, the base station controls transmission, in a plurality of cells, of a plurality of the DCI formats 2_0 each indicating the same slot format (or slot format combination) in the certain cell.

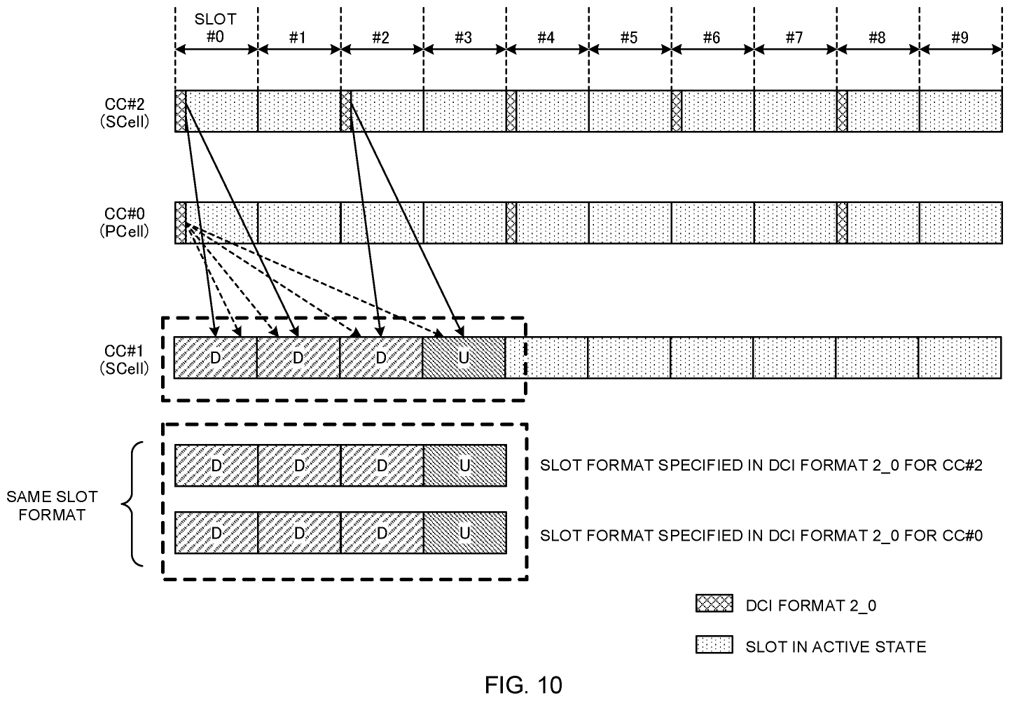

FIG. 10 is a diagram to show an example of the second determination operation for the slot format according to the second aspect. FIG. 10 shows that the user terminal performs carrier aggregation on a plurality of CCs (cells).

For example, in FIG. 10, a plurality of the DCI formats 2_0 indicating the slot format (or slot format combination) for CC #1 are detected in CC #0 and CC #2 (cross carrier monitoring). However, no such limitation is intended. One of the plurality of DCIs may be detected in CC #1 (same carrier monitoring).

In FIG. 10, CC #0 and CC #2 are different from each other in monitoring period, and the numbers of slots for which the slot format is specified by the DCI formats 2_0 are different from each other. However, no such limitation is intended. The numbers of slots may be the same for each of which the slot format is specified by a plurality of DCI formats 2_0.

For example, as shown in FIG. 10, the slot format (transmission direction) of slots #0 to #3 in CC #1 specified by one DCI format 2_0 in CC #0 is the same as the slot format of slots #0 to #3 in CC #1 specified by two DCI formats 2_0 in CC #2.

Even in a case where CC #0 and CC #2 are different from each other in monitoring period (the number of slots for which the slot format is specified by the DCI formats 2_0), the base station may control the SFI indices (or slot format combination) specified by the DCI formats 2_0 transmitted in CC #0 and CC #2 to indicate the same slot format in the same slot.

In the second determination operation, in a case where DCI format 2_0 for the certain cell is transmitted in a plurality of cells, the base station controls the SFI indices specified by the DCI formats 2_0 for a plurality of cells such that the same slot has the same slot format. Thus, the user terminal can appropriately and easily determine the slot format for the certain cell.

### <Third Determination Operation>

In a third determination operation, the user terminal expects to receive, in a plurality of cells, a plurality of the DCI formats 2_0 for the certain cell as is the case with the second determination operation.

The third determination operation differs from the second determination operation in that the user terminal assumes that a plurality of the DCI formats 2_0 for the certain cell transmitted with slots different from each other may indicate conflicting slot formats (or slot format combinations).

In a case where the plurality of DCI formats 2_0 for the certain cell are transmitted in different slots from different cells, the user terminal may determine the slot format for the certain cell based on the closest DCI format 2_0 of the plurality of DCI formats 2_0.

On the other hand, the user terminal may expect that the plurality of DCI formats 2_0 transmitted in the same slot indicate the same slot format (slot format combination) as is the case with the second determination operation. The base station may control generation of a plurality of the DCI formats 2_0 transmitted in the same slot by using different cells each indicating the same slot format (or slot format combination) for the certain cell.

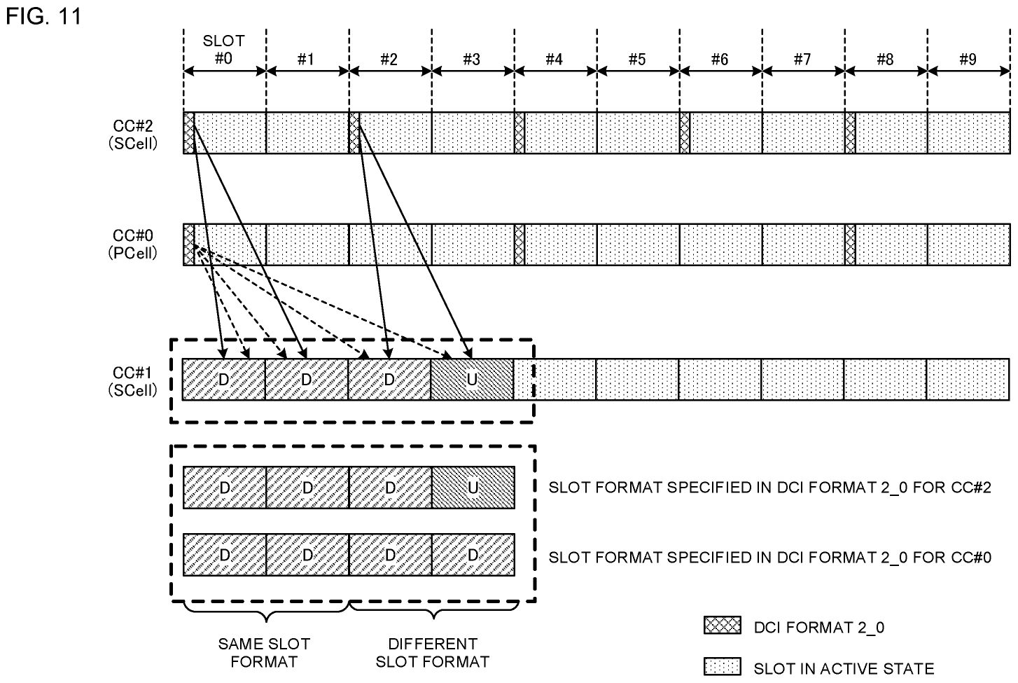

FIG. 11 is a diagram to show an example of the third determination operation for the slot format according to the second aspect. Description will be given with reference to FIG. 11 with differences from FIG. 10 focused on.

For example, in slot #0 in FIG. 11, DCI format 2_0 specifying the slot format for CC #1 is transmitted in both CC #0 and CC #2. In this case, the same slot format (transmission direction) is specified for slots #0 to #1 in CC #1 by one DCI format 2_0.

Meanwhile, in slot #2 in FIG. 11, DCI format 2_0 specifying the slot format for CC #1 is transmitted in CC #2. The slot format (transmission direction) of slots #3 to #4 specified by DCI format 2_0 conflicts with the slot format (transmission direction) of slots #3 to #4 specified in CC #0 in slot #0.

In this case, the user terminal may determine the slot format (transmission direction) of slots #3 to #4 based on DCI format 2_0 received in the closest slot #2 in CC #2. Alternatively, the user terminal may select DCI format 2_0 used to determine the slot format in accordance with another certain rule. The certain rule may correspond to, for example, DCI format 2_0 received in one of the CCs included in the same cell group, PUCCH group, or frequency band, the CC having the lowest CC index, DCI format 2_0 for which the BWP with the same subcarrier spacing as that for CC #2 is received in an active CC, or DCI format 2_0 received in a CC for which the same monitoring period and timing for DCI format 2_0 as that for CC #2 is configured.

According to the second aspect described above, the slot format for the certain cell can be appropriately determined in a case where the slot format for the certain cell is specified by DCI format 2_0 transmitted in at least one of a plurality of cells including the certain cell.

### (Other Aspects)

The first and second aspects may be used independently or in combination. For example, the transmission direction of the slot or symbol before the next monitoring occasion in the activated cell in the first determination operation (for example, FIG. 5) in the first aspect may be appropriately determined in accordance with the first to third determination operations in the second aspect.

The transmission direction of the slot or symbol before the next monitoring occasion in the activated cell in the first half duplex communication (for example, FIG. 7) in the first aspect may be appropriately determined in accordance with the first to third determination operations in the second aspect.

### (Radio Communication System)

Hereinafter, a structure of a radio communication system according to the present embodiment will be described. In this radio communication system, the radio communication method according to each embodiment of the present disclosure described above may be used alone or may be used in combination for communication.

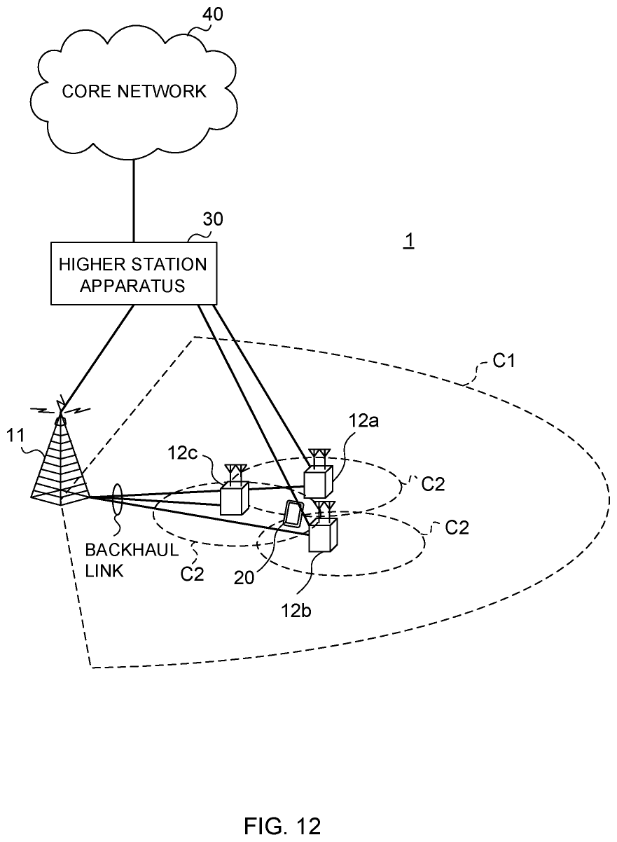

FIG. 12 is a diagram to show an example of a schematic structure of the radio communication system according to the present embodiment. A radio communication system 1 can adopt carrier aggregation (CA) and/or dual connectivity (DC) to group a plurality of fundamental frequency blocks (component carriers) into one, where the system bandwidth in an LTE system (for example, 20 MHz) constitutes one unit.

Note that the radio communication system 1 may be referred to as “LTE (Long Term Evolution),” “LTE-A (LTE-Advanced),” “LTE-B (LTE-Beyond),” “SUPER 3G,” “IMT-Advanced,” “4G (4th generation mobile communication system),” “5G (5th generation mobile communication system),” “NR (New Radio),” “FRA (Future Radio Access),” “New-RAT (Radio Access Technology),” and so on, or may be referred to as a system implementing these.

The radio communication system 1 includes a radio base station 11 that forms a macro cell C1 of a relatively wide coverage, and radio base stations 12 (12a to 12c) that form small cells C2, which are placed within the macro cell C1 and which are narrower than the macro cell C1. Also, user terminals 20 are placed in the macro cell C1 and in each small cell C2. The arrangement, the number, and the like of each cell and user terminal 20 are by no means limited to the aspect shown in the diagram.

The user terminals 20 can connect with both the radio base station 11 and the radio base stations 12. It is assumed that the user terminals 20 use the macro cell C1 and the small cells C2 at the same time by means of CA or DC. The user terminals 20 can execute CA or DC by using a plurality of cells (CCs).

Between the user terminals 20 and the radio base station 11, communication can be carried out by using a carrier of a relatively low frequency band (for example, 2 GHz) and a narrow bandwidth (referred to as, for example, an “existing carrier,” a “legacy carrier” and so on). Meanwhile, between the user terminals 20 and the radio base stations 12, a carrier of a relatively high frequency band (for example, 3.5 GHz, 5 GHz, and so on) and a wide bandwidth may be used, or the same carrier as that used between the user terminals 20 and the radio base station 11 may be used. Note that the structure of the frequency band for use in each radio base station is by no means limited to these.

The user terminals 20 can perform communication by using time division duplex (TDD) and/or frequency division duplex (FDD) in each cell. Furthermore, in each cell (carrier), a single numerology may be employed, or a plurality of different numerologies may be employed.

Numerologies may be communication parameters applied to transmission and/or reception of a certain signal and/or channel, and for example, may indicate at least one of a subcarrier spacing, a bandwidth, a symbol length, a cyclic prefix length, a subframe length, a TTI length, the number of symbols per TTI, a radio frame structure, a particular filter processing performed by a transceiver in a frequency domain, a particular windowing processing performed by a transceiver in a time domain, and so on. For example, if certain physical channels use different subcarrier spacings of the OFDM symbols constituted and/or different numbers of the OFDM symbols, it may be referred to as that the numerologies are different.

A wired connection (for example, means in compliance with the CPRI (Common Public Radio Interface) such as an optical fiber, an X2 interface and so on) or a wireless connection may be established between the radio base station 11 and the radio base stations 12 (or between two radio base stations 12).

The radio base station 11 and the radio base stations 12 are each connected with a higher station apparatus 30, and are connected with a core network 40 via the higher station apparatus 30. Note that the higher station apparatus 30 may be, for example, access gateway apparatus, a radio network controller (RNC), a mobility management entity (MME) and so on, but is by no means limited to these. Also, each radio base station 12 may be connected with the higher station apparatus 30 via the radio base station 11.

Note that the radio base station 11 is a radio base station having a relatively wide coverage, and may be referred to as a “macro base station,” a “central node,” an “eNB (eNodeB),” a “transmitting/receiving point” and so on. The radio base stations 12 are radio base stations having local coverages, and may be referred to as “small base stations,” “micro base stations,” “pico base stations,” “femto base stations,” “HeNBs (Home eNodeBs),” “RRHs (Remote Radio Heads),” “transmitting/receiving points” and so on. Hereinafter, the radio base stations 11 and 12 will be collectively referred to as “radio base stations 10 (base station),” unless specified otherwise.

Each of the user terminals 20 is a terminal that supports various communication schemes such as LTE and LTE-A, and may include not only mobile communication terminals (mobile stations) but stationary communication terminals (fixed stations).

In the radio communication system 1, as radio access schemes, orthogonal frequency division multiple access (OFDMA) is applied to the downlink, and single carrier frequency division multiple access (SC-FDMA) and/or OFDMA is applied to the uplink.

OFDMA is a multi-carrier communication scheme to perform communication by dividing a frequency band into a plurality of narrow frequency bands (subcarriers) and mapping data to each subcarrier. SC-FDMA is a single carrier communication scheme to mitigate interference between terminals by dividing the system bandwidth into bands formed with one or continuous resource blocks per terminal, and allowing a plurality of terminals to use mutually different bands. Note that the uplink and downlink radio access schemes are by no means limited to the combinations of these, and other radio access schemes may be used.

In the radio communication system 1, a downlink shared channel (PDSCH (Physical Downlink Shared Channel), which is used by each user terminal 20 on a shared basis, a broadcast channel (PBCH (Physical Broadcast Channel)), downlink L1/L2 control channels and so on, are used as downlink channels. User data, higher layer control information, SIBs (System Information Blocks) and so on are communicated on the PDSCH. The MIBs (Master Information Blocks) are communicated on the PBCH.

The downlink L1/L2 control channels include a PDCCH (Physical Downlink Control Channel), an EPDCCH (Enhanced Physical Downlink Control Channel), a PCFICH (Physical Control Format Indicator Channel), a PHICH (Physical Hybrid-ARQ Indicator Channel) and so on. Downlink control information (DCI), including PDSCH and/or PUSCH scheduling information, and so on are communicated on the PDCCH.

Note that the DCI scheduling DL data reception may be referred to as “DL assignment” and that the DCI scheduling UL data transmission may be referred to as “UL grant.”

The number of OFDM symbols to use for the PDCCH may be transmitted on the PCFICH. Transmission confirmation information (for example, also referred to as “retransmission control information,” “HARQ-ACK,” “ACK/NACK,” and so on) of HARQ (Hybrid Automatic Repeat reQuest) to a PUSCH may be transmitted on the PHICH. The EPDCCH is frequency-division multiplexed with the PDSCH (downlink shared data channel) and used to communicate DCI and so on, like the PDCCH.

In the radio communication system 1, an uplink shared channel (PUSCH (Physical Uplink Shared Channel)), which is used by each user terminal 20 on a shared basis, an uplink control channel (PUCCH (Physical Uplink Control Channel)), a random access channel (PRACH (Physical Random Access Channel)) and so on are used as uplink channels. User data, higher layer control information and so on are communicated on the PUSCH. In addition, radio quality information (CQI (Channel Quality Indicator)) of the downlink, transmission confirmation information, scheduling request (SR), and so on are transmitted on the PUCCH. By means of the PRACH, random access preambles for establishing connections with cells are communicated.

In the radio communication system 1, a cell-specific reference signal (CRS), a channel state information-reference signal (CSI-RS), a demodulation reference signal (DMRS), a positioning reference signal (PRS), and so on are transmitted as downlink reference signals. In the radio communication system 1, a measurement reference signal (SRS (Sounding Reference Signal)), a demodulation reference signal (DMRS), and so on are transmitted as uplink reference signals. Note that DMRS may be referred to as a “user terminal-specific reference signal (UE-specific Reference Signal).” Transmitted reference signals are by no means limited to these.

### <Radio Base Station>

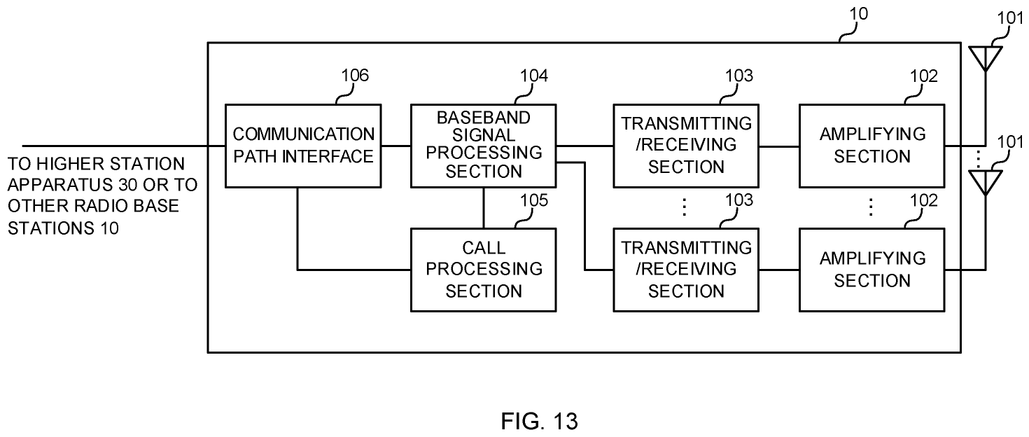

FIG. 13 is a diagram to show an example of an overall structure of the radio base station according to the present embodiment. A radio base station 10 includes a plurality of transmitting/receiving antennas 101, amplifying sections 102, transmitting/receiving sections 103, a baseband signal processing section 104, a call processing section 105 and a communication path interface 106. Note that the radio base station 10 may be configured to include one or more transmitting/receiving antennas 101, one or more amplifying sections 102 and one or more transmitting/receiving sections 103.

User data to be transmitted from the radio base station 10 to the user terminal 20 by the downlink is input from the higher station apparatus 30 to the baseband signal processing section 104, via the communication path interface 106.

In the baseband signal processing section 104, the user data is subjected to transmission processes, such as a PDCP (Packet Data Convergence Protocol) layer process, division and coupling of the user data, RLC (Radio Link Control) layer transmission processes such as RLC retransmission control, MAC (Medium Access Control) retransmission control (for example, an HARQ transmission process), scheduling, transport format selection, channel coding, an inverse fast Fourier transform (IFFT) process, and a precoding process, and the result is forwarded to each transmitting/receiving section 103. Furthermore, downlink control signals are also subjected to transmission processes such as channel coding and inverse fast Fourier transform, and the result is forwarded to each transmitting/receiving section 103.

The transmitting/receiving sections 103 convert baseband signals that are pre-coded and output from the baseband signal processing section 104 on a per antenna basis, to have radio frequency bands and transmit the result. The radio frequency signals having been subjected to frequency conversion in the transmitting/receiving sections 103 are amplified in the amplifying sections 102, and transmitted from the transmitting/receiving antennas 101. The transmitting/receiving sections 103 can be constituted with transmitters/receivers, transmitting/receiving circuits or transmitting/receiving apparatus that can be described based on general understanding of the technical field to which the present disclosure pertains. Note that each transmitting/receiving section 103 may be structured as a transmitting/receiving section in one entity, or may be constituted with a transmitting section and a receiving section.

Meanwhile, as for uplink signals, radio frequency signals that are received in the transmitting/receiving antennas 101 are amplified in the amplifying sections 102. The transmitting/receiving sections 103 receive the uplink signals amplified in the amplifying sections 102. The transmitting/receiving sections 103 convert the received signals into the baseband signal through frequency conversion and outputs to the baseband signal processing section 104.

In the baseband signal processing section 104, user data that is included in the uplink signals that are input is subjected to a fast Fourier transform (FFT) process, an inverse discrete Fourier transform (IDFT) process, error correction decoding, a MAC retransmission control receiving process, and RLC layer and PDCP layer receiving processes, and forwarded to the higher station apparatus 30 via the communication path interface 106. The call processing section 105 performs call processing (setting up, releasing and so on) for communication channels, manages the state of the radio base station 10, manages the radio resources and so on.

The communication path interface 106 transmits and/or receives signals to and/or from the higher station apparatus 30 via a certain interface. The communication path interface 106 may transmit and/or receive signals (backhaul signaling) with other radio base stations 10 via an inter-base station interface (for example, an optical fiber in compliance with the CPRI (Common Public Radio Interface) and an X2 interface).

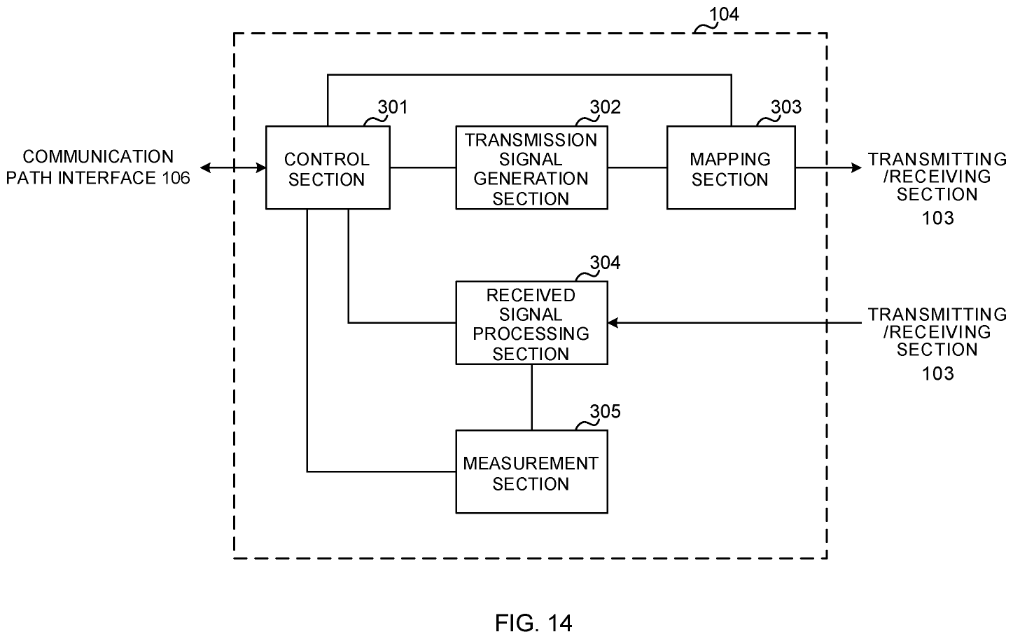

FIG. 14 is a diagram to show an example of a functional structure of the radio base station according to the present embodiment. Note that, the present example primarily shows functional blocks that pertain to characteristic parts of the present embodiment, and it is assumed that the radio base station 10 may include other functional blocks that are necessary for radio communication as well.

The baseband signal processing section 104 at least includes a control section (scheduler) 301, a transmission signal generation section 302, a mapping section 303, a received signal processing section 304, and a measurement section 305. Note that these structures may be included in the radio base station 10, and some or all of the structures do not need to be included in the baseband signal processing section 104.

The control section (scheduler) 301 controls the whole of the radio base station 10. The control section 301 can be constituted with a controller, a control circuit or control apparatus that can be described based on general understanding of the technical field to which the present disclosure pertains.

The control section 301, for example, controls the generation of signals in the transmission signal generation section 302, the mapping of signals by the mapping section 303, and so on. The control section 301 controls the signal receiving processes in the received signal processing section 304, the measurements of signals in the measurement section 305, and so on.

The control section 301 controls the scheduling (for example, resource assignment) of system information, a downlink data signal (for example, a signal transmitted on the PDSCH), a downlink control signal (for example, a signal transmitted on the PDCCH and/or the EPDCCH. Transmission confirmation information, and so on). Based on the results of determining necessity or not of retransmission control to the uplink data signal, or the like, the control section 301 controls generation of a downlink control signal, a downlink data signal, and so on.

The control section 301 controls the scheduling of a synchronization signal (for example, PSS (Primary Synchronization Signal)/SSS (Secondary Synchronization Signal)), a downlink reference signal (for example, CRS, CSI-RS, DMRS), and so on.

The control section 301 controls the scheduling of an uplink data signal (for example, a signal transmitted on the PUSCH), an uplink control signal (for example, a signal transmitted on the PUCCH and/or the PUSCH. Transmission confirmation information, and so on), a random access preamble (for example, a signal transmitted on the PRACH), an uplink reference signal, and so on.

The transmission signal generation section 302 generates downlink signals (downlink control signals, downlink data signals, downlink reference signals and so on) based on commands from the control section 301 and outputs the downlink signals to the mapping section 303. The transmission signal generation section 302 can be constituted with a signal generator, a signal generation circuit or signal generation apparatus that can be described based on general understanding of the technical field to which the present disclosure pertains.

The transmission signal generation section 302 generates DCI, based on commands from the control section 301, for example. For example, the DCI is at least one of DL assignment to report assignment information of the downlink data, UL grant to report assignment information of uplink data, DCI including the SFI, and so on. For a downlink data signal, encoding processing and modulation processing are performed in accordance with a coding rate, modulation scheme, or the like determined based on channel state information (CSI) from each user terminal 20. The downlink data signal may include information configured through higher layer signaling.

The mapping section 303 maps the downlink signals generated in the transmission signal generation section 302 to certain radio resources, based on commands from the control section 301, and outputs these to the transmitting/receiving sections 103. The mapping section 303 can be constituted with a mapper, a mapping circuit or mapping apparatus that can be described based on general understanding of the technical field to which the present disclosure pertains.

The received signal processing section 304 performs receiving processes (for example, demapping, demodulation, decoding and so on) of received signals that are input from the transmitting/receiving sections 103. Here, the received signals are, for example, uplink signals that are transmitted from the user terminals 20 (uplink control signals, uplink data signals, uplink reference signals and so on). The received signal processing section 304 can be constituted with a signal processor, a signal processing circuit or signal processing apparatus that can be described based on general understanding of the technical field to which the present disclosure pertains.

The received signal processing section 304 outputs the decoded information acquired through the receiving processes to the control section 301. For example, if the received signal processing section 304 receives the PUCCH including HARQ-ACK, the received signal processing section 304 outputs the HARQ-ACK to the control section 301. The received signal processing section 304 outputs the received signals and/or the signals after the receiving processes to the measurement section 305.

The measurement section 305 conducts measurements with respect to the received signals. The measurement section 305 can be constituted with a measurer, a measurement circuit or measurement apparatus that can be described based on general understanding of the technical field to which the present disclosure pertains.

For example, the measurement section 305 may perform RRM (Radio Resource Management) measurement, CSI (Channel State Information) measurement, and so on, based on the received signal. The measurement section 305 may measure a received power (for example, RSRP (Reference Signal Received Power)), a received quality (for example, RSRQ (Reference Signal Received Quality), an SINR (Signal to Interference plus Noise Ratio), an SNR (Signal to Noise Ratio)), a signal strength (for example, RSSI (Received Signal Strength Indicator)), channel information (for example, CSI), and so on. The measurement results may be output to the control section 301.

Note that the transmitting/receiving section 103 may transmit downlink control information (DCI). Specifically, the transmitting/receiving section 103 may transmit, in monitoring occasions with a certain period, downlink control information indicating the slot format for a certain cell. The transmitting/receiving section 103 may transmit, in the monitoring occasions with the certain period and in a plurality of cells, a plurality of pieces of downlink control information each indicating the slot format for the certain cell.

The transmitting/receiving section 103 may transmit information related to uplink and downlink configurations for time division duplex (TDD) of the certain cell signaled in a higher layer in a cell-specific or user-terminal-specific manner (at least one of the cell-specific TDD-UL-DL configuration information and the user-terminal-specific TDD-UL-DL configuration information).

The control section 301 may control the slot formats for one or more cells. Specifically, the control section 301 may control transmission of the downlink control information in at least one of a plurality of cells including the certain cell (second aspect).

For example, the control section 301 may control transmission of the downlink control information in one of the plurality of cells (second aspect, first determination operation). The control section 301 may control transmission, in the plurality of cells, of a plurality of pieces of downlink control information each indicating the same slot format for the certain cell (second aspect, second determination operation).

In a case where the certain cell is activated, the control section 301 may control transmission of the downlink control information used to determine the slot format for the slot or symbol before the next monitoring occasion in the certain cell (first aspect).

The control section 301 may perform control such that, to the user terminal performing half duplex communication, between one or more cells including the certain cell in a certain frequency band, communication in the same transmission direction is performed in the same slot or symbol (first aspect, half duplex communication).

The control section 301 may control transmission of one or more pieces of downlink control information indicating the same slot format for the same slot between the one or more cells (first aspect, half duplex communication). The control section 301 may control transmission of information indicating the same slot format for the same slot and related to uplink and downlink configurations for time division duplex (TDD) subjected to cell- or user-terminal-specific higher layer signaling (first aspect, half duplex communication).

### <User Terminal>

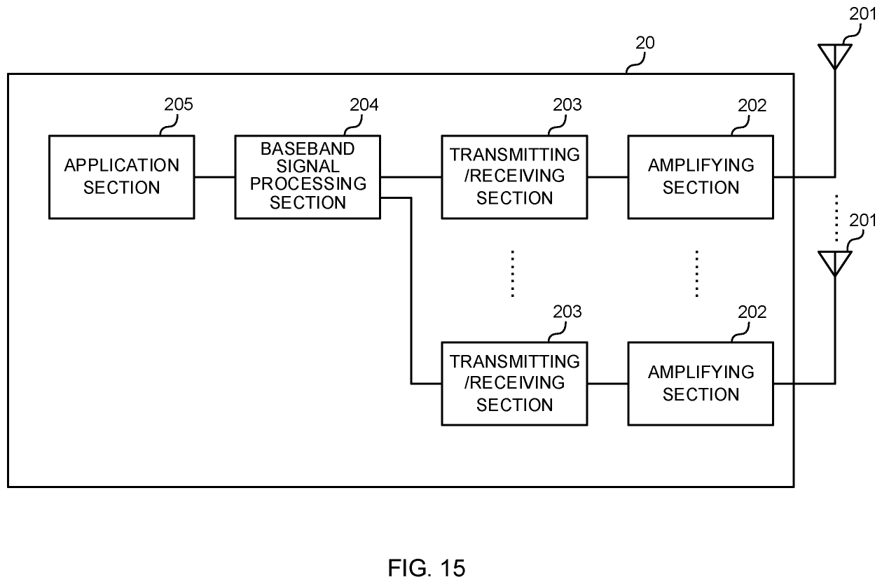

FIG. 15 is a diagram to show an example of an overall structure of the user terminal according to the present embodiment. A user terminal 20 includes a plurality of transmitting/receiving antennas 201, amplifying sections 202, transmitting/receiving sections 203, a baseband signal processing section 204 and an application section 205. Note that the user terminal 20 may be configured to include one or more transmitting/receiving antennas 201, one or more amplifying sections 202 and one or more transmitting/receiving sections 203.

Radio frequency signals that are received in the transmitting/receiving antennas 201 are amplified in the amplifying sections 202. The transmitting/receiving sections 203 receive the downlink signals amplified in the amplifying sections 202. The transmitting/receiving sections 203 convert the received signals into baseband signals through frequency conversion, and output the baseband signals to the baseband signal processing section 204. The transmitting/receiving sections 203 can be constituted with transmitters/receivers, transmitting/receiving circuits or transmitting/receiving apparatus that can be described based on general understanding of the technical field to which the present disclosure pertains. Note that each transmitting/receiving section 203 may be structured as a transmitting/receiving section in one entity, or may be constituted with a transmitting section and a receiving section.

The baseband signal processing section 204 performs, on each input baseband signal, an FFT process, error correction decoding, a retransmission control receiving process, and so on. The downlink user data is forwarded to the application section 205. The application section 205 performs processes related to higher layers above the physical layer and the MAC layer, and so on. In the downlink data, broadcast information may be also forwarded to the application section 205.

Meanwhile, the uplink user data is input from the application section 205 to the baseband signal processing section 204. The baseband signal processing section 204 performs a retransmission control transmission process (for example, an HARQ transmission process), channel coding, precoding, a discrete Fourier transform (DFT) process, an IFFT process and so on, and the result is forwarded to the transmitting/receiving section 203.

The transmitting/receiving sections 203 convert the baseband signals output from the baseband signal processing section 204 to have radio frequency band and transmit the result. The radio frequency signals having been subjected to frequency conversion in the transmitting/receiving sections 203 are amplified in the amplifying sections 202, and transmitted from the transmitting/receiving antennas 201.

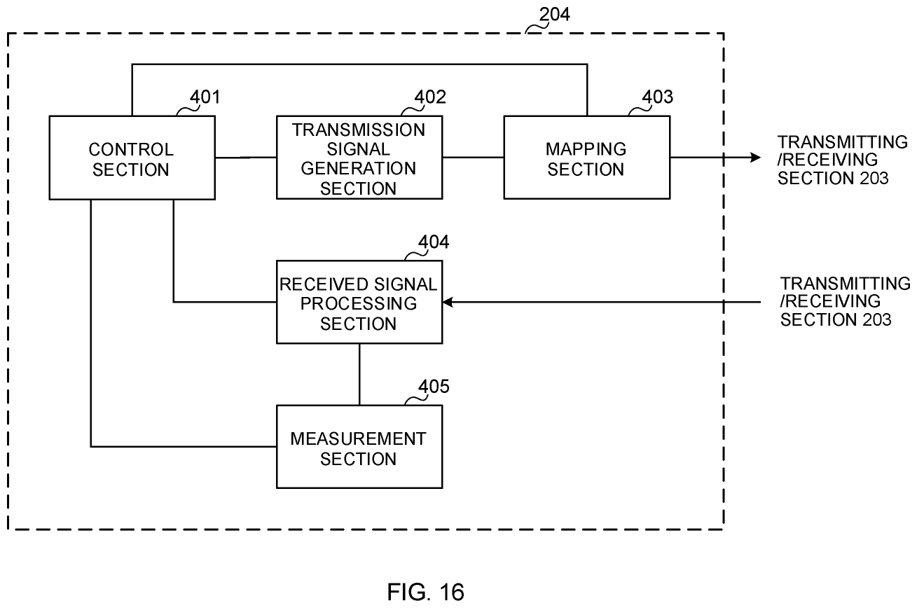

FIG. 16 is a diagram to show an example of a functional structure of the user terminal according to the present embodiment. Note that, the present example primarily shows functional blocks that pertain to characteristic parts of the present embodiment, and it is assumed that the user terminal 20 may include other functional blocks that are necessary for radio communication as well.

The baseband signal processing section 204 provided in the user terminal 20 at least includes a control section 401, a transmission signal generation section 402, a mapping section 403, a received signal processing section 404 and a measurement section 405. Note that these structures may be included in the user terminal 20, and some or all of the structures do not need to be included in the baseband signal processing section 204.

The control section 401 controls the whole of the user terminal 20. The control section 401 can be constituted with a controller, a control circuit or control apparatus that can be described based on general understanding of the technical field to which the present disclosure pertains.

The control section 401, for example, controls the generation of signals in the transmission signal generation section 402, the mapping of signals by the mapping section 403, and so on. The control section 401 controls the signal receiving processes in the received signal processing section 404, the measurements of signals in the measurement section 405, and so on.

The control section 401 acquires a downlink control signal and a downlink data signal transmitted from the radio base station 10, from the received signal processing section 404. The control section 401 controls generation of an uplink control signal and/or an uplink data signal, based on the results of determining necessity or not of retransmission control to a downlink control signal and/or a downlink data signal, and so on.

If the control section 401 acquires a variety of information reported by the radio base station 10 from the received signal processing section 404, the control section 401 may update parameters to use for control, based on the information.

The transmission signal generation section 402 generates uplink signals (uplink control signals, uplink data signals, uplink reference signals and so on) based on commands from the control section 401, and outputs the uplink signals to the mapping section 403. The transmission signal generation section 402 can be constituted with a signal generator, a signal generation circuit or signal generation apparatus that can be described based on general understanding of the technical field to which the present disclosure pertains.

For example, the transmission signal generation section 402 generates an uplink control signal about transmission confirmation information, the channel state information (CSI), and so on, based on commands from the control section 401. The transmission signal generation section 402 generates uplink data signals, based on commands from the control section 401. For example, when a UL grant is included in a downlink control signal that is reported from the radio base station 10, the control section 401 commands the transmission signal generation section 402 to generate the uplink data signal.

The mapping section 403 maps the uplink signals generated in the transmission signal generation section 402 to radio resources, based on commands from the control section 401, and outputs the result to the transmitting/receiving sections 203. The mapping section 403 can be constituted with a mapper, a mapping circuit or mapping apparatus that can be described based on general understanding of the technical field to which the present disclosure pertains.

The received signal processing section 404 performs receiving processes (for example, demapping, demodulation, decoding and so on) of received signals that are input from the transmitting/receiving sections 203. Here, the received signals are, for example, downlink signals transmitted from the radio base station 10 (downlink control signals, downlink data signals, downlink reference signals and so on). The received signal processing section 404 can be constituted with a signal processor, a signal processing circuit or signal processing apparatus that can be described based on general understanding of the technical field to which the present disclosure pertains. The received signal processing section 404 can constitute the receiving section according to the present disclosure.

The received signal processing section 404 outputs the decoded information acquired through the receiving processes to the control section 401. The received signal processing section 404 outputs, for example, broadcast information, system information, RRC signaling, DCI and so on, to the control section 401. The received signal processing section 404 outputs the received signals and/or the signals after the receiving processes to the measurement section 405.

The measurement section 405 conducts measurements with respect to the received signals. The measurement section 405 can be constituted with a measurer, a measurement circuit or measurement apparatus that can be described based on general understanding of the technical field to which the present disclosure pertains.

For example, the measurement section 405 may perform RRM measurement, CSI measurement, and so on, based on the received signal. The measurement section 405 may measure a received power (for example, RSRP), a received quality (for example, RSRQ, SINR, SNR), a signal strength (for example, RSSI), channel information (for example, CSI), and so on. The measurement results may be output to the control section 401.

Note that the transmitting/receiving section 203 may receive downlink control information (DCI). Specifically, the transmitting/receiving section 203 may receive, in monitoring occasions with a certain period, downlink control information indicating the slot format for a certain cell. The transmitting/receiving section 203 may receive, in the monitoring occasions with the certain period and in a plurality of cells, a plurality of pieces of downlink control information each indicating the slot format for the certain cell.

The transmitting/receiving section 203 may transmit information related to uplink and downlink configurations for time division duplex (TDD) of the certain cell and signaled in a higher layer in a cell-specific or user-terminal-specific manner (at least one of the cell-specific TDD-UL-DL configuration information and the user-terminal-specific TDD-UL-DL configuration information).

The control section 401 may control the transmission directions of slots or symbols in one or more cells. In a case where certain cell is activated, the control section 401 may determine the slot format for the slot or symbol before the next monitoring occasion in the certain cell (first aspect).

The control section 401 may determine the slot format based on the downlink control information received in a cell other than the certain cell before the next monitoring occasion (first aspect, first determination operation).

The control section 401 may determine the slot format based on information related to uplink and downlink configurations for time division duplex (TDD) in the certain cell and signaled in a higher layer in a cell- or user-terminal-specific manner (first aspect, second and third determination operations).

In this case, the control section 401 may monitor the PDCCH in configured flexible symbols. In the configured flexible symbols, the control section 401 may cancel (second determination operation) or perform (third determination operation) at least one of transmission of the UL signal and reception of the DL signal configured through higher layer signaling.

In a case where the user terminal 20 performs half duplex communication, the control section 401 need not assume execution of reception of the downlink signal and transmission of the uplink signal in the same slot or the same symbol, between one or more cells including the certain cell in a certain frequency band.

In a case of receiving, in monitoring occasions with a certain period and in a plurality of cells, a plurality of pieces of downlink control information each indicating a slot format for a certain cell, the control section 401 may determine the slot format for the certain cell based on at least one of the plurality of pieces of downlink control information (second aspect).

The control section 401 may determine the slot format for the certain cell on the assumption that the plurality of pieces of downlink control information indicate the same slot format (second aspect, second determination operation). Alternatively, the control section 401 may determine the slot format for the certain cell based on the closest one of the plurality of pieces of downlink control information received (second aspect, third determination operation).

### <Hardware Structure>

Note that the block diagrams that have been used to describe the above embodiments show blocks in functional units. These functional blocks (components) may be implemented in arbitrary combinations of hardware and/or software. Also, the method for implementing each functional block is not particularly limited. That is, each functional block may be realized by one piece of apparatus that is physically and/or logically aggregated, or may be realized by directly and/or indirectly connecting two or more physically and/or logically separate pieces of apparatus (via wire and/or wireless, for example) and using these plurality of pieces of apparatus.

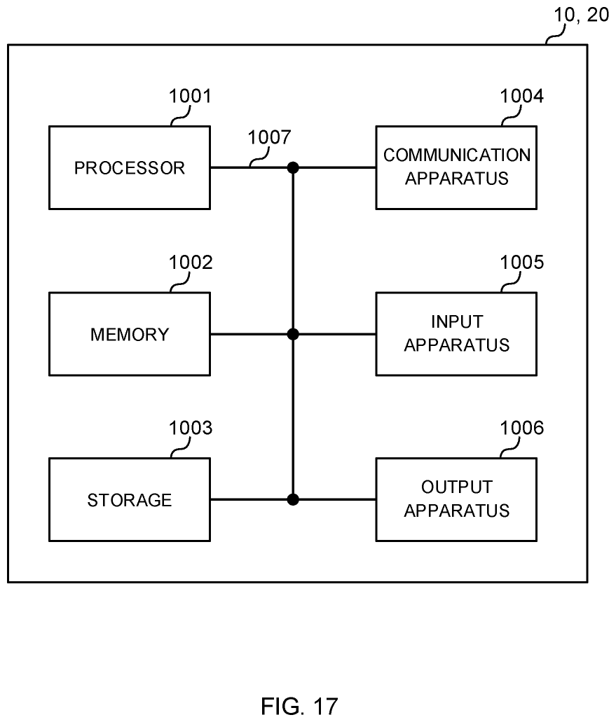

For example, a radio base station, a user terminal, and so on according to the present embodiment may function as a computer that executes the processes of the radio communication method of the present disclosure. FIG. 17 is a diagram to show an example of a hardware structure of the radio base station and the user terminal according to the present embodiment. Physically, the above-described radio base station 10 and user terminals 20 may each be formed as computer apparatus that includes a processor 1001, a memory 1002, a storage 1003, a communication apparatus 1004, an input apparatus 1005, an output apparatus 1006, a bus 1007, and so on.

Note that, in the following description, the word “apparatus” may be interpreted as “circuit,” “device,” “unit,” and so on. The hardware structure of the radio base station 10 and the user terminals 20 may be designed to include one or a plurality of apparatuses shown in the drawings, or may be designed not to include part of pieces of apparatus.

For example, although only one processor 1001 is shown, a plurality of processors may be provided. Furthermore, processes may be implemented with one processor or may be implemented at the same time, in sequence, or in different manners with one or more processors. Note that the processor 1001 may be implemented with one or more chips.

Each function of the radio base station 10 and the user terminals 20 is implemented, for example, by allowing certain software (programs) to be read on hardware such as the processor 1001 and the memory 1002, and by allowing the processor 1001 to perform calculations to control communication via the communication apparatus 1004 and read and/or write data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, the above-described baseband signal processing section 104 (204), call processing section 105, and so on may be implemented by the processor 1001.

Furthermore, the processor 1001 reads programs (program codes), software modules, data, and so on from the storage 1003 and/or the communication apparatus 1004, into the memory 1002, and executes various processes according to these. As for the programs, programs to allow computers to execute at least part of the operations of the above-described embodiments are used. For example, the control section 401 of each user terminal 20 may be implemented by control programs that are stored in the memory 1002 and that operate on the processor 1001, and other functional blocks may be implemented likewise.

The memory 1002 is a computer-readable recording medium, and may be constituted with, for example, at least one of a ROM (Read Only Memory), an EPROM (Erasable Programmable ROM), an EEPROM (Electrically EPROM), a RAM (Random Access Memory), and other appropriate storage media. The memory 1002 may be referred to as a “register,” a “cache,” a “main memory (primary storage apparatus)” and so on. The memory 1002 can store executable programs (program codes), software modules, and/or the like for implementing a radio communication method according to the present embodiment.

The storage 1003 is a computer-readable recording medium, and may be constituted with, for example, at least one of a flexible disk, a floppy (registered trademark) disk, a magneto-optical disk (for example, a compact disc (CD-ROM (Compact Disc ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via wired and/or wireless networks, and may be referred to as, for example, a “network device,” a “network controller,” a “network card,” a “communication module” and so on. The communication apparatus 1004 may be configured to include a high frequency switch, a duplexer, a filter, a frequency synthesizer, and so on in order to realize, for example, frequency division duplex (FDD) and/or time division duplex (TDD). For example, the above-described transmitting/receiving antennas 101 (201), amplifying sections 102 (202), transmitting/receiving sections 103 (203), communication path interface 106, and so on may be implemented by the communication apparatus 1004.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, an LED (Light Emitting Diode) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the radio base station 10 and the user terminals 20 may be structured to include hardware such as a microprocessor, a digital signal processor (DSP), an ASIC (Application Specific Integrated Circuit), a PLD (Programmable Logic Device), an FPGA (Field Programmable Gate Array), and so on, and part or all of the functional blocks may be implemented by the hardware. For example, the processor 1001 may be implemented with at least one of these pieces of hardware.

### (Variations)

Note that the terminology used in this specification and/or the terminology that is needed to understand this specification may be replaced by other terms that convey the same or similar meanings. For example, “channels” and/or “symbols” may be replaced by “signals” (“signaling”). Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

Furthermore, a radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may have a fixed time length (for example, 1 ms) independent of numerology.

Furthermore, a slot may be constituted of one or a plurality of symbols in the time domain (OFDM (Orthogonal Frequency Division Multiplexing) symbols, SC-FDMA (Single Carrier Frequency Division Multiple Access) symbols, and so on). Furthermore, a slot may be a time unit based on numerology. A slot may include a plurality of mini-slots. Each mini-slot may be constituted of one or a plurality of symbols in the time domain. A mini-slot may be referred to as a “sub-slot.”

A radio frame, a subframe, a slot, a mini-slot, and a symbol all express time units in signal communication. A radio frame, a subframe, a slot, a mini-slot, and a symbol may each be called by other applicable terms. For example, one subframe may be referred to as a “transmission time interval (TTI),” a plurality of consecutive subframes may be referred to as a “TTI” or one slot or one mini-slot may be referred to as a “TTI.” That is, a subframe and/or a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a radio base station schedules the allocation of radio resources (such as a frequency bandwidth and transmission power that are available for each user terminal) for the user terminal in TTI units. Note that the definition of TTIs is not limited to this.

TTIs may be transmission time units for channel-encoded data packets (transport blocks), code blocks, and/or codewords, or may be the unit of processing in scheduling, link adaptation, and so on. Note that, when TTIs are given, the time interval (for example, the number of symbols) to which transport blocks, code blocks and/or codewords are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in LTE Rel. 8 to Rel. 12), a “long TTI,” a “normal subframe,” a “long subframe” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. Also, an RB may include one or a plurality of symbols in the time domain, and may be one slot, one mini-slot, one subframe, or one TTI in length. One TTI and one subframe each may be constituted of one or a plurality of resource blocks. Note that one or a plurality of RBs may be referred to as a “physical resource block (PRB (Physical RB)),” a “sub-carrier group (SCG),” a “resource element group (REG),”a “PRB pair,” an “RB pair” and so on.

Furthermore, a resource block may be constituted of one or a plurality of resource elements (REs). For example, one RE may correspond to a radio resource field of one subcarrier and one symbol.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in this specification may be represented in absolute values or in relative values with respect to certain values, or may be represented in another corresponding information. For example, radio resources may be specified by certain indices.

The names used for parameters and so on in this specification are in no respect limiting. For example, since various channels (PUCCH (Physical Uplink Control Channel), PDCCH (Physical Downlink Control Channel), and so on) and information elements can be identified by any suitable names, the various names assigned to these individual channels and information elements are in no respect limiting.

The information, signals, and/or others described in this specification may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output from higher layers to lower layers and/or from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in this specification, and other methods may be used as well. For example, reporting of information may be implemented by using physical layer signaling (for example, downlink control information (DCI), uplink control information (UCI)), higher layer signaling (for example, RRC (Radio Resource Control) signaling, broadcast information (master information block (MIB), system information blocks (SIBs), and so on), MAC (Medium Access Control) signaling and so on), and other signals and/or combinations of these.

Note that physical layer signaling may be referred to as “L1/L2 (Layer 1/Layer 2) control information (L1/L2 control signals),” “L1 control information (L1 control signal),” and so on. Also, RRC signaling may be referred to as an “RRC message,” and can be, for example, an RRC connection setup (RRCConnectionSetup) message, an RRC connection reconfiguration (RRCConnectionReconfiguration) message, and so on. Also, MAC signaling may be reported using, for example, MAC control elements (MAC CEs).

Also, reporting of certain information (for example, reporting of “X holds”) does not necessarily have to be reported explicitly, and can be reported implicitly (by, for example, not reporting this certain information or reporting another piece of information).

Determinations may be made in values represented by one bit (0 or 1), may be made in Boolean values that represent true or false, or may be made by comparing numerical values (for example, comparison against a certain value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using wired technologies (coaxial cables, optical fiber cables, twisted-pair cables, digital subscriber lines (DSL), and so on) and/or wireless technologies (infrared radiation, microwaves, and so on), these wired technologies and/or wireless technologies are also included in the definition of communication media.

The terms “system” and “network” as used in this specification are used interchangeably.

In the present specification, the terms “base station (BS),” “radio base station,” “eNB,” “gNB,” “cell,” “sector,” “cell group,” “carrier,” and “component carrier” may be used interchangeably. A base station may be referred to as a “fixed station,” “NodeB,” “eNodeB (eNB),” “access point,” “transmission point,” “receiving point,” “femto cell,” “small cell” and so on.

A base station can accommodate one or a plurality of (for example, three) cells (also referred to as “sectors”). When a base station accommodates a plurality of cells, the entire coverage area of the base station can be partitioned into multiple smaller areas, and each smaller area can provide communication services through base station subsystems (for example, indoor small base stations (RRHs (Remote Radio Heads))). The term “cell” or “sector” refers to part of or the entire coverage area of a base station and/or a base station subsystem that provides communication services within this coverage.

In the present specification, the terms “mobile station (MS),” “user terminal,” “user equipment (UE),” and “terminal” may be used interchangeably.

A mobile station may be referred to as, by a person skilled in the art, a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

Furthermore, the radio base stations in this specification may be interpreted as user terminals. For example, each aspect/embodiment of the present disclosure may be applied to a configuration in which communication between a radio base station and a user terminal is replaced with communication among a plurality of user terminals (D2D (Device-to-Device)). In this case, the user terminals 20 may have the functions of the radio base stations 10 described above. In addition, wording such as “uplink” and “downlink” may be interpreted as “side.” For example, an uplink channel may be interpreted as a side channel.

Likewise, the user terminals in this specification may be interpreted as radio base stations. In this case, the radio base stations 10 may have the functions of the user terminals 20 described above.

Actions which have been described in this specification to be performed by a base station may, in some cases, be performed by upper nodes. In a network including one or a plurality of network nodes with base stations, it is clear that various operations that are performed to communicate with terminals can be performed by base stations, one or more network nodes (for example, MMEs (Mobility Management Entities), S-GW (Serving-Gateways), and so on may be possible, but these are not limiting) other than base stations, or combinations of these.

The aspects/embodiments illustrated in this specification may be used individually or in combinations, which may be switched depending on the mode of implementation. The order of processes, sequences, flowcharts, and so on that have been used to describe the aspects/embodiments herein may be re-ordered as long as inconsistencies do not arise. For example, although various methods have been illustrated in this specification with various components of steps in exemplary orders, the specific orders that are illustrated herein are by no means limiting.

The aspects/embodiments illustrated in this specification may be applied to LTE (Long Term Evolution), LTE-A (LTE-Advanced), LTE-B (LTE-Beyond), SUPER 3G, IMT-Advanced, 4G (4th generation mobile communication system), 5G (5th generation mobile communication system), FRA (Future Radio Access), New-RAT (Radio Access Technology), NR(New Radio), NX (New radio access), FX (Future generation radio access), GSM (registered trademark) (Global System for Mobile communications), CDMA 2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark), systems that use other adequate radio communication methods and/or next-generation systems that are enhanced based on these.

The phrase “based on” (or “on the basis of”) as used in this specification does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second” and so on as used herein does not generally limit the quantity or order of these elements. These designations may be used herein only for convenience, as a method for distinguishing between two or more elements. Thus, reference to the first and second elements does not imply that only two elements may be employed, or that the first element must precede the second element in some way.

The term “judging (determining)” as used herein may encompass a wide variety of actions. For example, “judging (determining)” may be interpreted to mean making “judgments (determinations)” about calculating, computing, processing, deriving, investigating, looking up (for example, searching a table, a database, or some other data structures), ascertaining, and so on. Furthermore, “judging (determining)” may be interpreted to mean making “judgments (determinations)” about receiving (for example, receiving information), transmitting (for example, transmitting information), input, output, accessing (for example, accessing data in a memory), and so on. In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

The terms “connected” and “coupled,” or any variation of these terms as used herein mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In this specification, when two elements are connected, the two elements may be considered “connected” or “coupled” to each other by using one or more electrical wires, cables and/or printed electrical connections, and, as some non-limiting and non-inclusive examples, by using electromagnetic energy having wavelengths in radio frequency regions, microwave regions, (both visible and invisible) optical regions, or the like.

In this specification, the phrase “A and B are different” may mean that “A and B are different from each other.” The terms “separate,” “be coupled” and so on may be interpreted similarly.

When terms such as “including,” “comprising,” and variations of these are used in this specification or in claims, these terms are intended to be inclusive, in a manner similar to the way the term “provide” is used. Furthermore, the term “or” as used in this specification or in claims is intended to be not an exclusive disjunction.

Now, although the invention according to the present disclosure has been described in detail above, it should be obvious to a person skilled in the art that the invention according to the present disclosure is by no means limited to the embodiments described in this specification. The invention according to the present disclosure can be implemented with various corrections and in various modifications, without departing from the spirit and scope of the invention defined by the recitations of claims. Consequently, the description in this specification is provided only for the purpose of explaining examples, and should by no means be construed to limit the invention according to the present disclosure in any way.

1. A base station comprising:
transmitting section that transmits, in monitoring occasions with a certain period, downlink control information indicating a slot format for a certain cell, and
a control section that controls transmission of the downlink control information in at least one of a plurality of cells including the certain cell.

2. The base station according to claim 1, wherein
the control section controls transmission of the downlink control information in one of the plurality of cells.

3. The base station according to claim 1, wherein
the control section controls transmission, in one of the plurality of cells, of a plurality of pieces of the downlink control information each indicating an identical slot format for the certain cell.

4. The base station according to claim 1, wherein
in a case of activating the certain cell, the control section controls transmission of the downlink control information used to determine the slot format for a slot or a symbol before a next monitoring occasion in the certain cell.

5. The base station according to claim 1, wherein
the control section performs control such that, between a user terminal performing half duplex communication and one or more cells including the certain cell in a certain frequency band, communication in an identical transmission direction is performed in an identical slot or symbol.

6. The base station according to claim 5, wherein the control section controls at least one of:
transmission of one or more pieces of the downlink control information indicating the identical slot format for the identical slot between the one or more sells, and
transmission of information indicating the identical slot format for the identical slot and related to uplink and downlink configurations for time division duplex (TDD) subjected to cell- or UE-specific higher layer signaling.

7. The base station according to claim 2, wherein
in a case of activating the certain cell, the control section controls transmission of the downlink control information used to determine the slot format for a slot or a symbol before a next monitoring occasion in the certain cell.

8. The base station according to claim 3, wherein
in a case of activating the certain cell, the control section controls transmission of the downlink control information used to determine the slot format for a slot or a symbol before a next monitoring occasion in the certain cell.

9. The base station according to claim 2, wherein
the control section performs control such that, between a user terminal performing half duplex communication and one or more cells including the certain cell in a certain frequency band, communication in an identical transmission direction is performed in an identical slot or symbol.

10. The base station according to claim 3, wherein
the control section performs control such that, between a user terminal performing half duplex communication and one or more cells including the certain cell in a certain frequency band, communication in an identical transmission direction is performed in an identical slot or symbol.

11. The base station according to claim 4, wherein
the control section performs control such that, between a user terminal performing half duplex communication and one or more cells including the certain cell in a certain frequency band, communication in an identical transmission direction is performed in an identical slot or symbol.
